(19) United States
(12) Patent Application Publication
(10) Pub. No.: US 2017/0200137 A1
(43) Pub. Date: Jul. 13, 2017

(54) COMBINED SECURITY FOR ELECTRONIC TRANSFERS

(71) Applicant: The Western Union Company, Englewood, CA (US)

(72) Inventor: Victor Vilmont, San Francisco, CA (US)

(73) Assignee: The Western Union Company, Englewood, CO (US)

(21) Appl. No.: 14/991,736

(22) Filed: Jan. 8, 2016

(51) Int. Cl. G06Q 20/10; G06Q 20/42; G06Q 20/32; G06Q 30/02; G06Q 20/06

(52) U.S. Cl. CPC G06Q 20/10; G06Q 30/0215; G06Q 20/06; G06Q 20/3224; G06Q 20/42; G06Q 30/0213

(57) ABSTRACT

Techniques described herein relate to receiving and handling multi-user electronic transfer requests involving client devices at different locations or domains within a transfer system. In response to received transfer requests, a number of granter system offers may be evaluated based combinations of sender credentials and receiver credentials. One or more combinations of qualifying offers may be identified having aggregate values sufficient to cover the requested transfer value. From the qualifying offer combinations, a specific set of offers may be determined for performing the requested transfer, and the transfer may be initiated between a sender device in a first location and a receiver device in a second location within the transfer system.

### BACKGROUND OF THE INVENTION

Field of the Invention

The present invention relates generally to receiving and handling secure transfers between devices at different locations or domains within electronic transfer networks.

Description of the Related Art

Within electronic data transfer networks, one or more central transfer servers along with various intermediary computing infrastructure and communication networks may be used to initiate and perform secure transfers between sender devices and receiver devices. In some cases, sender devices and receiver devices for a requested transfer may operate at separate locations or domains with a larger transfer system, and thus may have different networks and different subsets of available resources may be available to the different devices within the requested transaction. Central transfer servers and other computing systems may determine and assign resources for performing requested transfers, for example, by evaluating credentials of senders and the sender devices initiating the requested transfers.

### BRIEF SUMMARY

Various techniques (e.g., systems, methods, computer-program products tangibly embodied in a non-transitory machine-readable storage medium, etc.) are described herein for receiving and handling transfer requests involving client devices at different locations or domains within a transfer system. In some embodiments, one or more transfer servers may receive transfer requests from sender devices and/or receiver devices associated with different locations or domains within a transfer system. Transfer servers may receive and evaluate offers from a number of granter systems in response to the requested transfer between the sender device and receiver device. In some cases, specific granter systems and/or specific offers may be available only within certain locations or domains with a transfer system, and not within other locations or domains. Transfer servers may evaluate the offers for the requested transfer based on sender credentials, receiver credentials, and/or a combination of sender and receiver credentials, and may identify one or more combinations of qualifying offers having aggregate values sufficient to cover the requested transfer value. From the qualifying offer combinations, a specific set of offers may be determined for performing the requested transfer, and the transfer may be initiated between the sender device in a first location and the receiver device in a second location within the transfer system.

Certain additional techniques discussed herein relate to selecting specific combinations of offers from granter systems available in different locations, to use for transfers between a sender devices and receiver devices in different locations or domains. In some embodiments, sender credentials only may be initially used to identify a first set of offers available at the sender's location. In response to the identified first set of offers, the sender's credentials may be updated, and a second set of offers may be identified at the receiver's location based on the updated sender's credentials. The sender's credentials may be updated again in response to the identified second set of offers, and a combination of the receiver's credentials and the updated sender's credentials may be generated. Using the combination of receiver and updated sender credentials, an additional set of available offers may be identified across the sender's location and the receiver's location. Finally, a number of qualifying offer combinations may be generated from the combined sets of available offers, and a selected or optimal offer combination may be identified to use for performing the requested transfer.

### BRIEF DESCRIPTION OF THE DRAWINGS

FIG. 1 is a block diagram showing illustrating an example of an electronic transfer network, according to one or more embodiments of the disclosure.

FIG. 2 is a block diagram illustrating various components and features of a digital kiosk client device, according to one or more embodiments of the disclosure.

FIG. 3 is a block diagram illustrating a computer server and computing environment within an electronic transfer network, according to one or more embodiments of the disclosure.

FIG. 4 is a block diagram illustrating an embodiment of one or more data store servers within an electronic transfer network, according to one or more embodiments of the disclosure.

FIG. 5 is a block diagram illustrating an embodiment of one or more content management servers within an electronic transfer network, according to one or more embodiments of the disclosure.

FIG. 6 is a block diagram illustrating the physical and logical components of a special-purpose computer device within an electronic transfer network, according to one or more embodiments of the disclosure.

FIG. 7 is a block diagram illustrating an example transfer system including sender and receiver devices, granter systems, and one or more transfer servers, according to one or more embodiments of the disclosure.

FIG. 8 is a flow diagram illustrating an example process of determining and presenting offer combinations in response to received transfer requests, according to one or more embodiments of the disclosure.

FIGS. 9A and 9B illustrate another flow diagram showing an example process of determining qualifying offer combinations based on combined sender and receiver credentials, according to one or more embodiments of the disclosure.

FIG. 10 is an illustrative data table containing a plurality example offers associated with locations and granter systems, according to one or more embodiments of the disclosure.

In the appended figures, similar components and/or features may have the same reference label. Further, various compo of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides illustrative embodiment(s) only and is not intended to limit the scope, applicability or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

Various techniques (e.g., systems, methods, computer-program products tangibly embodied in a non-transitory computer-readable storage medium, etc.) are described herein for receiving and handling transfer requests involving client devices at different locations or domains within a transfer system. In some embodiments, one or more transfer servers may receive transfer requests from sender devices and/or receiver devices associated with different locations or domains within a transfer system. Transfer servers may receive and evaluate offers from a number of granter systems in response to the requested transfer between the sender device and receiver device. In some cases, specific granter systems and/or specific offers may be available only within certain locations or domains with a transfer system, and not within other locations or domains. Transfer servers may evaluate the offers for the requested transfer based on sender credentials, receiver credentials, and/or a combination of sender and receiver credentials, and may identify one or more combinations of qualifying offers having aggregate values sufficient to cover the requested transfer value. From the qualifying offer combinations, a specific set of offers may be determined for performing the requested transfer, and the transfer may be initiated between the sender device in a first location and the receiver device in a second location within the transfer system.

In accordance with certain techniques discussed herein, specific combinations of offers may be selected from granter systems available in different locations, to use for transfers between a sender devices and receiver devices in different locations or domains. In some embodiments, sender credentials only may be initially used to identify a first set of offers available at the sender's location. In response to the identified first set of offers, the sender's credentials may be updated, and a second set of offers may be identified at the receiver's location based on the updated sender's credentials. The sender's credentials may be updated again in response to the identified second set of offers, and a combination of the receiver's credentials and the updated sender's credentials may be generated. Using the combination of receiver and updated sender credentials, an additional set of available offers may be identified across the sender's location and the receiver's location. Finally, a number of qualifying offer combinations may be generated from the combined sets of available offers, and a selected or optimal offer combinations may be identified to use for performing the requested transfer

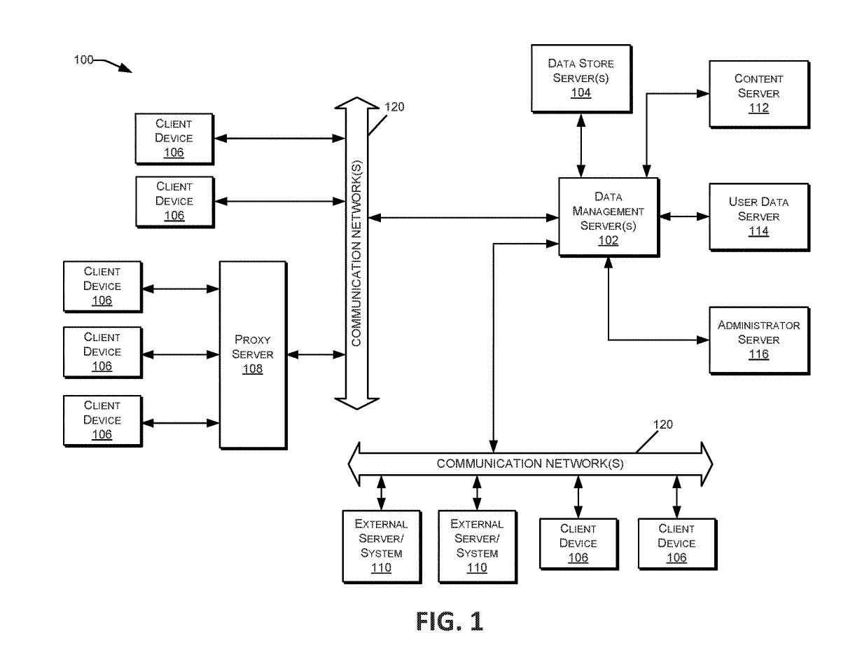

With reference now to FIG. 1, a block diagram is shown illustrating various components of an electronic transfer network 100 which implements and supports certain embodiments and features described herein. As discussed below in more detail, various embodiments of electronic transfer networks 100 may be implemented and configured to perform secure transfers between client devices 106, systems servers (e.g., 102), and/or external systems 110. In some embodiments, the various computing devices and systems shown in FIG. 1 may correspond to different physical or virtual domains/regions, for instance, different geographic areas within different jurisdictions, different data centers, different networks, different computing infrastructures, etc. As described herein, secure transfers may include transfers of various different types of data items (e.g., files, database records, media or other content resources, etc.), as well as other secure data transactions or other interactions between a sender and receiver devices/servers. In some embodiments, the electronic transfer network 100 may be configured to operate as a value transfer system by which users at client devices 106 may initiate value transfers to users at other client devices 106. In such cases, management servers 102 and/or external systems 110 may correspond to secure systems operated by financial institutions or other entities, by which sender and receiver credentials and value transfer requests may be received and analyzed, and value-based transactions may be authorized and performed.

Thus, in various embodiments, electronic transfer network 100 may be configured to support and perform transfers of various currency types, including traditional and/or digital currencies, centralized and/or de-centralized currencies, cryptocurrencies, and any other medium of exchange (e.g., credit, gift cards or certificates, points in a user point system, etc.), between client devices 106 and/or external systems 110 in different areas, regions, or jurisdictions. In other embodiments, the electronic transfer network 100 may be configured to perform other types of multi-party data transfers and/or secure transactions, such as transfers of data items including secure files, records, and/or content resources, between client devices 106 and other client devices 106, management servers 102 and/or external systems 110. For such transfers, the endpoint systems may be operating in the same location, using the same communication networks 120, and/or using the same computing hardware and software infrastructure, or may operate in different locations, on different networks, and/or in different datacenters, etc. Data management servers 102 and relate servers (e.g., 104, 108, 112, 114, 116, etc.) in some embodiments, may correspond to authentication systems, data access/permission systems, subscription monitor systems, network access providers, and/or any other servers that may be used to monitor, permit/deny access, and/or enable data transfers. In still other embodiments, network 100 may be implemented as part of interactive gaming systems, educational and profession training systems, and/or social network systems, to enable the transfer of certain data or values (e.g., points, credits, resources, etc.) between users on different systems and/or in different locations.

As shown in FIG. 1, electronic transfer network 100 may include one or more data management servers 102. Data management servers 102 may be any desired type of server including, for example, a rack server, a tower server, a miniature server, a blade server, a mini rack server, a mobile server, an ultra-dense server, a super server, or the like, and may include various hardware components, for example, a motherboard, a processing units, memory systems, hard drives, network interfaces, power supplies, etc. Data management servers 102 may include one or more server farms, clusters, or any other appropriate arrangement and/or combination or computer servers. Data management servers 102 may act according to stored instructions located in a memory subsystem of the servers 102, and may run an operating system, including any commercially available server operating system and/or any other operating systems discussed herein.

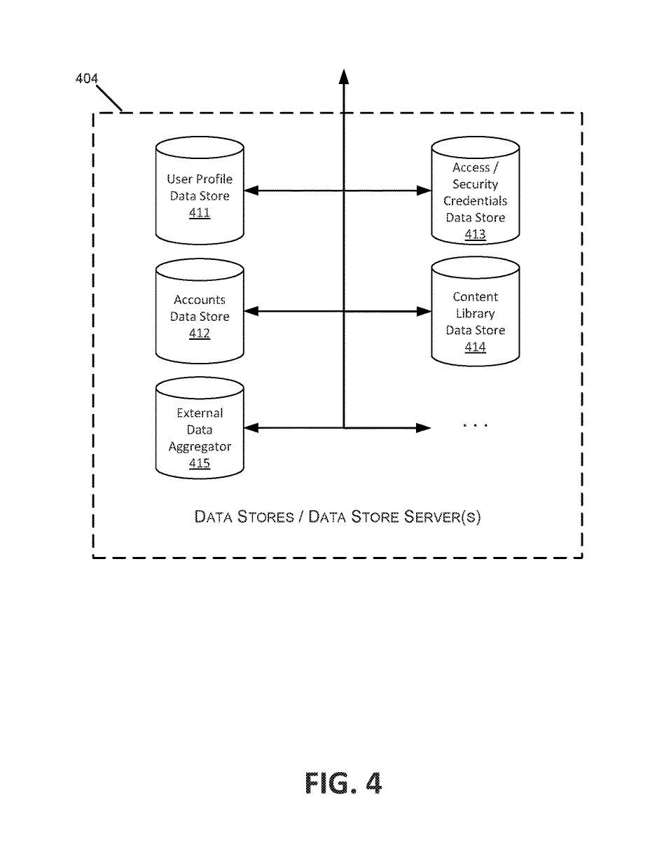

The electronic transfer network 100 may include one or more data store servers 104, such as database servers and file-based storage systems. Data stores 104 may comprise stored data relevant to the functions of the electronic transfer network 100. Illustrative examples of data stores 104 that may be maintained in certain embodiments of the electronic transfer network 100 are described below in reference to FIG. 4. In some embodiments, multiple data stores may reside on a single server 104, either using the same storage components of server 104 or using different physical storage components to assure data security and integrity between data stores. In other embodiments, each data store may have a separate dedicated data store server 104.

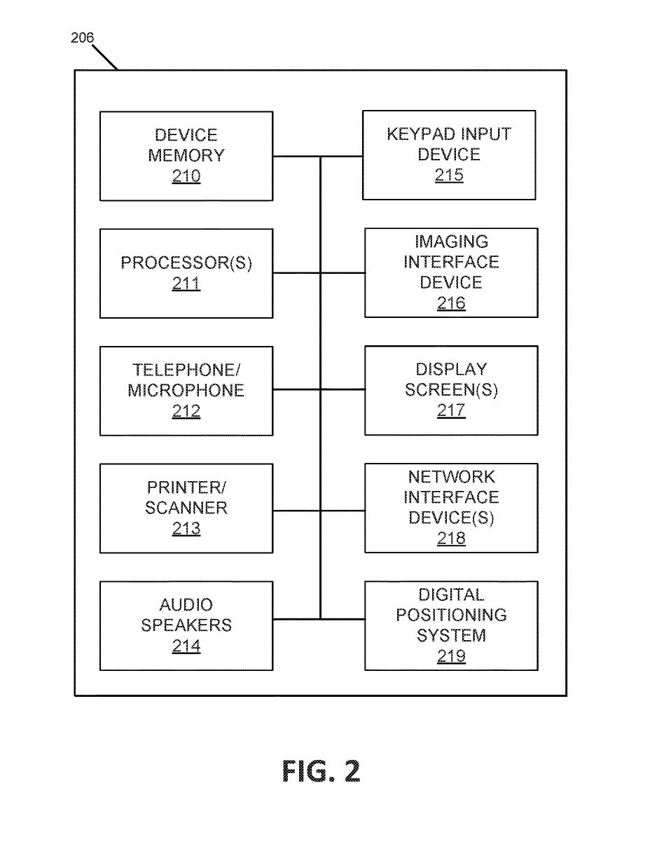

Electronic transfer network 100 also may include one or more client devices 106. Client devices 106 may display data received via the electronic transfer network 100, and may support various types of user interactions with the data. Client devices 106 may include mobile devices such as smartphones, tablet computers, personal digital assistants, and wearable computing devices. Such mobile devices may run a variety of mobile operating systems, and may be enabled for Internet, e-mail, short message service (SMS), Bluetooth®, mobile radio-frequency identification (M-RFID), and/or other communication protocols. Other client devices 106 may be general purpose personal computers or special-purpose computing devices including, by way of example, personal computers, laptop computers, workstation computers, projection devices, and interactive room display systems. Additionally, client devices 106 may be any other electronic devices, such as thin-client computers, Internet-enabled gaming systems, business or home appliances, and/or personal messaging devices, capable of communicating over network(s) 120. In some embodiments, one or more client devices 106 may include digital kiosk devices such as point-of-sale terminals, value transfer terminals, and/or digital advertising or display devices, including some or all of the features described below in reference to FIG. 2.

In different contexts of electronic transfer networks 100, client devices 106 may correspond to different types of specialized devices, for example, employee devices and presentation devices in a company network, gaming devices in a gaming network, networked point-of-sale terminals or digital advertising terminals in a retail network, etc. In some embodiments, client devices 106 may operate in the same physical location, such as the conference room or same store. In such cases, the devices 106 may contain components that support direct communications with other nearby devices 106, such as a wireless transceivers and wireless communications interfaces, Ethernet sockets or other Local Area Network (LAN) interfaces, etc. In other implementations, the client devices 106 need not be used at the same physical location, but may be used in remote geographic locations in which each client device 106 may use security features and/or specialized hardware (e.g., hardware-accelerated SSL and HTTPS, WS-Security, firewalls, etc.) to communicate with the data management server 102 and/or other remotely located client devices 106. Additionally, different client devices 106 may be assigned different designated roles, such as sender devices, receiver devices, administrator devices, or the like, and in such cases the different devices may be provided with additional hardware and/or software components to provide content and support user capabilities not available to the other devices.

The electronic transfer network 100 also may include one or more proxy servers 108 configured to operate between a set of related client devices 106 and the back-end server(s) 102. In some cases, proxy server 108 may maintain private user information for client devices 106 interacting with applications or services hosted on other servers. For example, the proxy server 108 may be used to maintain private data of a user within one jurisdiction even though the user is accessing an application hosted on a server (e.g., the data management server 102) located outside the jurisdiction. In such cases, the proxy server 108 may intercept communications between multiple different client devices 106 and/or other devices that may include private user information. The proxy server 108 may create a token or identifier that does not disclose the private information and may use the token or identifier when communicating with the other servers and systems, instead of using the user's private information.

The electronic transfer network 100 also may include one or more external servers/systems 110 configured to connect to the back-end server(s) 102 through various communication networks 120 and/or through proxy servers 108. External servers/systems 110 may include some or all of the same physical and logical components as the data management server(s) 102, and may be configured to provide various data sources and/or services to the other components of the electronic transfer network 100.

As illustrated in FIG. 1, the data management server 102 may be in communication with one or more additional servers, such as a content server 112, a user data server 112, and/or an administrator server 116. Each of these servers may include some or all of the same physical and logical components as the data management server(s) 102, and in some cases, the hardware and software components of these servers 112-116 may be incorporated into the data management server(s) 102, rather than being implemented as separate computer servers.

Content server 112 may include hardware and software components to generate, store, and maintain the content resources for distribution to client devices 106 and other devices in the network 100. For example, in electronic transfer networks 100 used for professional training and educational purposes, content server 112 may include data stores of training materials, presentations, interactive programs and simulations, and various training interfaces that correspond to different materials and/or different types of user devices 106. In content electronic transfer networks 100 used for distribution of media content, advertising, and the like, a content server 112 may include media and advertising content files.

User data server 114 may include hardware and software components that store and process data for multiple users relating to each user's activities and usage of the electronic transfer network 100. For example, the data management server 102 may record and track each user's system usage, including their client device 106, data accessed and transferred, and interactions with other client devices 106. This data may be stored and processed by the user data server 114, to support user tracking and analysis features. For instance, in business training contexts, the user data server 114 may store and analyze each user's training materials viewed, courses completed, interactions, and the like. In the context of advertising, media distribution, and interactive gaming, the user data server 114 may store and process resource access data for multiple users (e.g., data files accessed, access times, data usage amounts, user histories, user devices and device types, etc.).

Administrator server 116 may include hardware and software components to initiate various administrative functions at the data management server 102 and other components within the content distribution network 100. For example, the administrator server 116 may monitor device status and performance for the various servers, data stores, and/or client devices 106 in the electronic transfer network 100. When necessary, the administrator server 116 may add or remove devices from the network 100, and perform device maintenance such as providing software updates to the devices in the network 100. Various administrative tools on the administrator server 116 may allow authorized users to set user access permissions to various data resources, monitor resource usage by users and devices 106, and perform analyses and generate reports on specific network users and/or devices (e.g., resource usage tracking reports, training evaluations, etc.).

The electronic transfer network 100 may include one or more communication networks 120. Although two networks 120 are identified in FIG. 1, the electronic transfer network 100 may include any number of different communication networks between any of the computer servers and devices shown in FIG. 1 and/or other devices described herein. Communication networks 120 may enable communication between the various computing devices, servers, and other components of the electronic transfer network 100. As discussed below, various implementations of electronic transfer networks 100 may employ different types of networks 120, for example, computer networks, telecommunications networks, wireless networks, and/or any combination of these and/or other networks.

As noted above, in certain embodiments, electronic transfer network 100 may be a cryptocurrency network or other network using encryption protocols and techniques for performing transfers of cryptocurrency and/or other alternative digital currencies. Illustrative and non-limiting examples of such cryptocurrency networks may include a bitcoin peer-to-peer (P2P) payment network, a Litecoin network, a Peercoin network, and various other private digital cryptocurrency networks. The various computing devices and servers in such cryptocurrency networks 100, including client devices 106, management servers 102, and/or external systems 110, may be configured to perform cryptocurrency transfers as senders and/or receivers. For example, a client device 106 may securely store a private cryptographic key associated with a cryptocurrency account of a user, and may use specialized client software (e.g., cryptocurrency wallet application) to generate digital cryptographic signatures using the private cryptographic key and data identifying the details of the requested cryptocurrency transfer. In some cases, the cryptocurrency client application may execute a cryptographic hash function to generate a hash value signature based on the private key value associated with the cryptocurrency account. Recipient client devices 106, as well as other servers/systems in the network 100, may use the public key of the sender to decrypt the cryptographic signature and verify the authenticity of the requested cryptocurrency transfer. Some or all of the client devices 106, servers 102, and/or external systems 110 may use databases or other secure storage to independently maintain and update electronic ledgers for tracking the current balances associated with cryptocurrency accounts.

In some embodiments, certain computing devices and servers in a cryptocurrency network 100 may function as miner systems that are configured to perform complex mathematical operations in order to produce new cryptocurrency. Thus, various client devices 106, servers 102, and/or external systems 110 may be implemented as cryptocurrency miners. In some cases, these devices/systems may include specialized hardware and software designed for cryptocurrency mining, such as application-specific integrated circuits (ASICs) that are specifically designed and configured for cryptocurrency mining and/or specialized cryptocurrency mining software. In some cases, specialized cryptocurrency mining software may be used to allow collaboration between multiple different devices/systems which may function as a mining pool.

In some embodiments, various computing devices and servers in a cryptocurrency network 100 may be configured to collaboratively generate and store universal public ledgers and/or transaction chains for the cryptocurrency network 100. For example, computing devices and systems within the cryptocurrency network 100 may be configured to retrieve individual cryptocurrency transactions from a pool and resolve the transactions by solving associated mathematical problems, such as cryptographic hashes. After the problem is solved, the associated cryptocurrency transaction may be added to a universal transaction chain which is shared by other devices and systems of the cryptocurrency network 100. Each device/system in the cryptocurrency network 100 may independent maintain a copy of the transaction chain, and may periodically (or upon request from other systems) share their copy of the transaction chain in order to synchronize and reconcile different versions.

In some embodiments, a transaction chain for a cryptocurrency system/network may be stored in a distributed database by multiple different data nodes at different devices/servers within the network 100. For example, blockchain technology may be used to implement a decentralized distributed database which may be hosted by a combination of client devices 106, data management servers 102, and/or external systems 110. The blockchain (or other decentralized storage system) may store a distributed electronic ledger and/or universal transaction chain for the cryptocurrency network 100. The blockchain may be accessed by individual client software (e.g., wallet applications) of client devices 106, which may propose a cryptocurrency value transfer to be added to the blockchain. After analyzing and authorizing the requested transfer (e.g., by confirming that there is sufficient cryptocurrency value in the sender's account), a miner node within the cryptocurrency network 100 may bundle the transfer with other transactions to create a new block to be added to the blockchain. In some cases, adding blocks to the blockchain may involve miner nodes repeatedly executing cryptographic hash functions, ensuring that the blockchain cannot be tampered with by any malicious systems within the network 100.

As noted above, the client devices 106 in the electronic transfer network 100 may include various mobile devices, such as smartphones, tablet computers, personal digital assistants, wearable computing devices, bodily implanted communication devices, vehicle-based devices, etc. Within an electronic transfer network 100, mobile devices 106 may be configured to support mobile payment and/or mobile money transfer functionality. Such mobile devices 106 may initiate and receive communications via the Internet, e-mail, short message service (SMS), Bluetooth®, mobile radio-frequency identification (M-RFID), near-field communication (NFC) and/or various other communication protocols. In some cases, mobile devices 106 may execute a mobile wallet application to store user data and support secure data and/or value transfers via various different techniques, for example, SMS-based transactional payments, direct mobile billing, Web Application Protocol mobile payments, and NFC-based payments.

In some examples, the electronic transfer network 100 shown in FIG. 1 may correspond to an interactive user platform, such as a social networking platform or messaging platform. In such cases, an electronic transfer technology platform may be integrated within the social networking and/or messaging platform 100, in order to provide interactive users with the capabilities to perform quick and convenient value transfers with other users anywhere in the world. Such embodiments may apply to various different collaborative user platforms and applications, including social media applications, email applications, chat and messaging applications, online gaming applications, and the like. These applications may be executed on client devices 106 and may transmit communications to and/or establish communication sessions with corresponding applications on other client devices 106 and/or external systems 110. In some embodiments, the secure data and/or value transfer capabilities of one or more transfer services providers may be embedded into various collaborative user platforms. For example, from within a social networking or messaging application running on client device 106, a user may be able to request and fund value transfers utilizing a debit card, credit card, or bank account, and easily direct the funds to another user on the same collaborative platform, or to retail agent location and/or to a mobile wallet or bank account. Integration of secure value transfer technologies within social networking applications, messaging applications, and the like, may provide a cross-border platform for transfer services that enables pay-in and pay-out capabilities that leverage technology, foreign exchange conversion, data management, as well as regulatory, compliance and anti-money laundering (AML) infrastructure of the transfer service provider, to expedite efficient and timely transfers. In such cases, the technology platform used to support secure data and/or value transfers within the network 100 may be accessible to messaging, social, and other digital networks, and may offer a suite of APIs built on a highly scalable infrastructure, enabling fast deployment of domestic and cross-border remittance capabilities.

Referring now to FIG. 2, a simplified block diagram is illustrating showing a digital kiosk device 206. In some embodiments, digital kiosk devices 206 may be another example of client devices 106. The digital kiosk device 206 may be implemented, for example, as a kiosk in a retail store, a value transfer terminal for performing value transfers (e.g., transfers of money and other assets, submitting payments to payees, etc.), a point-of-sale terminal, an electronic advertising system, and/or other various electronic display systems. The digital kiosk device 206 may be operated by a user (e.g., customer, shopper), and/or by agent, employee, or representative of a business providing or operating the kiosk 206. In various embodiments, the digital kiosk device 206 may include one or more of: a memory system 210, a processing unit 211, a telephone/microphone I/O component system 212, a printer/scanner I/O component system 213, an audio speaker system 214, a keypad input device 215, an imaging interface device 216, one or more digital display screens 217, one or more network interface devices 218 (e.g., network interface controllers, RF transceivers, etc.), and a digital positioning system 219 (e.g., Global Positioning System (GPS) receiver device). In various embodiments, digital kiosk devices 206 may include a touch screen that functions as the display screen 217 and/or the keypad 215. The keypad 215 may instead be any device that accepts user input, such as a trackball, mouse, or joystick. The imaging interface device 216 may serve to allow the digital kiosk device 206 to communicate with an imaging device. Alternatively, an imaging device may be directly incorporated into the digital kiosk device 206. Speakers 214 may be any audio output device. The printer 213 may be used to provide the user a receipt, point-of-sale information (e.g., product information, order confirmation, etc.), coupon, advertisement, or other information to be taken with the user, and scanner 213 may be used to scan a QR Code or barcode identifying a user or transaction, transfer request, user identification card, coupon, or the like. In some embodiments, a telephone/microphone 212 may be used in conjunction with speakers 214 to interact with the digital kiosk device 206, or a remotely located user (e.g., counterpart user in a transaction, customer representative, etc.) when performing a transfer or requesting information. Digital kiosk devices 206 may include various different types of digital position systems 219 (or geo-location systems 219), such as a Global Positioning System (GPS) receiver, so that kiosk location data may be collected and returned to data management servers 102 and/or other client devices 106. In some cases, such kiosk location data may be used to determine which content a specific digital kiosk device 206 is permitted to receive (e.g., based on domain/jurisdiction), and also may be used to determine factors such as language, data availability, network availability, product availability, and the like.

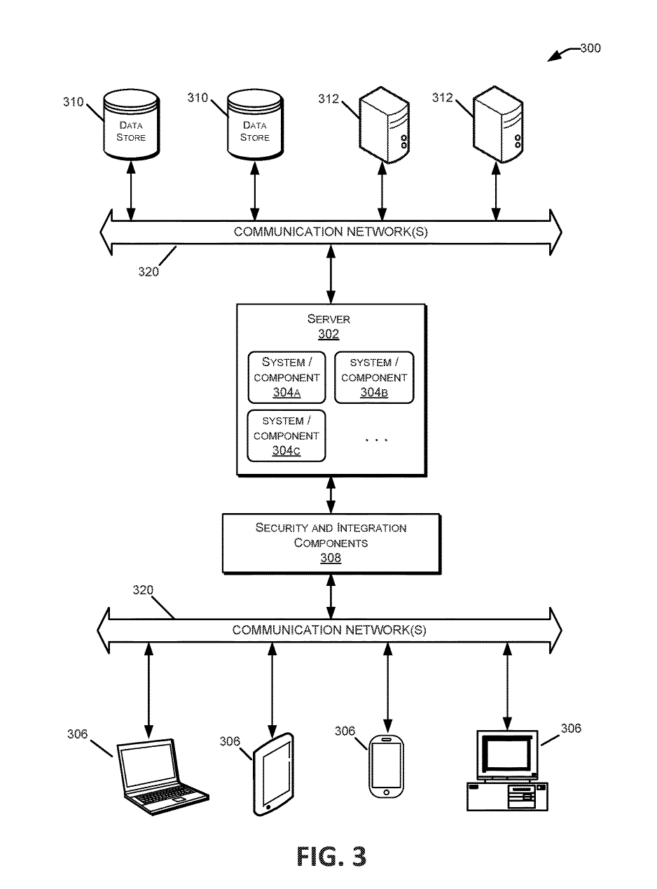

With reference to FIG. 3, an illustrative distributed computing environment 300 is shown including a computer server 302, four client computing devices 306, and other components that may implement certain embodiments and features described herein. In some embodiments, the server 302 may correspond to the data management server 102 discussed above in FIG. 1, and the client computing devices 306 may correspond to the client devices 106 and/or 206. However, the computing environment 300 illustrated in FIG. 3 also may correspond to any other combination of devices and servers configured to implement a client-server model or other distributed computing architecture.

Client devices 306 may be configured to receive and execute client applications over one or more networks 320. Such client applications may be web browser based applications and/or standalone software applications, such as mobile device applications. Server 302 may be communicatively coupled with the client devices 306 via one or more communication networks 220. Client devices 306 may receive client applications from server 302 or from other application providers (e.g., public or private application stores). Server 302 may be configured to run one or more server software applications or services, for example, web-based or cloud-based services, to support content distribution and interaction with client devices 306. Users operating client devices 306 may in turn utilize one or more client applications (e.g., virtual client applications) to interact with server 302 to utilize the services provided by these components.

Various different subsystems and/or components 304 may be implemented on server 302. Users operating the client devices 306 may initiate one or more client applications to use services provided by these subsystems and components. The subsystems and components within the server 302 and client devices 306 may be implemented in hardware, firmware, software, or combinations thereof. Various different system configurations are possible in different distributed computing systems 300 and electronic transfer networks 100. The embodiment shown in FIG. 3 is thus one example of a distributed computing system and is not intended to be limiting.

Although exemplary computing environment 300 is shown with four client computing devices 306, any number of client computing devices may be supported. Such client 306 may include digital kiosk devices including some or all of the features described below in reference to FIG. 2. Other devices, such as specialized sensor devices, etc., may interact with client devices 306 and/or server 302.

As shown in FIG. 3, various security and integration components 308 may be used to send and manage communications between the server 302 and user devices 306 over one or more communication networks 320. The security and integration components 308 may include separate servers, such as web servers and/or authentication servers, and/or specialized networking components, such as firewalls, routers, gateways, load balancers, and the like. In some cases, the security and integration components 308 may correspond to a set of dedicated hardware and/or software operating at the same physical location and under the control of same entities as server 302. For example, components 308 may include one or more dedicated web servers and network hardware in a datacenter or a cloud infrastructure. In other examples, the security and integration components 308 may correspond to separate hardware and software components which may be operated at a separate physical location and/or by a separate entity.

Security and integration components 308 may implement various security features for data transmission and storage, such as authenticating users and restricting access to unknown or unauthorized users. In various implementations, security and integration components 308 may provide, for example, a file-based integration scheme or a service-based integration scheme for transmitting data between the various devices in the electronic transfer network 100. Security and integration components 308 also may use secure data transmission protocols and/or encryption for data transfers, for example, File Transfer Protocol (FTP), Secure File Transfer Protocol (SFTP), and/or Pretty Good Privacy (PGP) encryption.

In some embodiments, one or more web services may be implemented within the security and integration components 308 and/or elsewhere within the electronic transfer network 100. Such web services, including cross-domain and/or cross-platform web services, may be developed for enterprise use in accordance with various web service standards, such as RESTful web services (i.e., services based on the Representation State Transfer (REST) architectural style and constraints), and/or web services designed in accordance with the Web Service Interoperability (WS-I) guidelines. Some web services may use the Secure Sockets Layer (SSL) or Transport Layer Security (TLS) protocol to provide secure connections between the server 302 and client devices 306. SSL or TLS may use HTTP or HTTPS to provide authentication and confidentiality. In other examples, web services may be implemented using REST over HTTPS with the OAuth open standard for authentication, or using the WS-Security standard which provides for secure SOAP messages using XML encryption. In other examples, the security and integration components 308 may include specialized hardware for providing secure web services. For example, security and integration components 308 may include secure network appliances having built-in features such as hardware-accelerated SSL and HTTPS, WS-Security, and firewalls. Such specialized hardware may be installed and configured in front of any web servers, so that any external devices may communicate directly with the specialized hardware.

Communication network(s) 320 may be any type of network familiar to those skilled in the art that can support data communications using any of a variety of commercially-available protocols, including without limitation, TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), Bluetooth®, Near Field Communication (NFC), and the like. Merely by way of example, network(s) 320 may be local area networks (LAN), such as one based on Ethernet, Token-Ring and/or the like. Network(s) 320 also may be wide-area networks, such as the Internet. Networks 320 may include telecommunication networks such as a public switched telephone networks (PSTNs), or virtual networks such as an intranet or an extranet. Infrared and wireless networks (e.g., using the Institute of Electrical and Electronics (IEEE) 802.11 protocol suite or other wireless protocols) also may be included in networks 320.

Computing environment 300 also may include one or more data stores 310 and/or back-end servers 312. In certain examples, the data stores 310 may correspond to data store server(s) 104 discussed above in FIG. 1, and back-end servers 312 may correspond to the various back-end servers 110-116. Data stores 310 and servers 312 may reside in the same datacenter or may operate at a remote location from server 302. In some cases, one or more data stores 310 may reside on a non-transitory storage medium within the server 302. Other data stores 310 and back-end servers 312 may be remote from server 302 and configured to communicate with server 302 via one or more networks 320. In certain embodiments, data stores 310 and back-end servers 312 may reside in a storage-area network (SAN), or may use a storage-as-a-service (STaaS) architectural model.

With reference to FIG. 4, an illustrative set of data stores and/or data store servers is shown, corresponding to the data store servers 104 of the electronic transfer network 100 discussed above in FIG. 1. One or more individual data stores 411-415 may reside in storage on a single computer server 104 (or a single server farm or cluster) under the control of a single entity, or may reside on separate servers operated by different entities and/or at remote locations. In some embodiments, data stores 411-415 may be accessed by the data management server 102 and/or other devices and servers within the network 100 (e.g., client devices 106, external systems 110, administrator servers 116, etc.). Access to one or more of the data stores 411-415 may be limited or denied based on the processes, user credentials, and/or devices attempting to interact with the data store.

The paragraphs below describe examples of specific data stores that may be implemented within some embodiments of an electronic transfer network 100. It should be understood that the below descriptions of data stores 411-415, including their functionality and types of data stored therein, are illustrative and non-limiting. Data stores server architecture, design, and the execution of specific data stores 411-415 may depend on the context, size, and functional requirements of an electronic transfer network 100. For example, in a secure data transfer systems 100 used for professional training, separate databases or file-based storage systems may be implemented in data store server(s) 104 to store trainee and/or trainer data, training module data and content descriptions, training results, evaluation data, and the like. In contrast, in electronic transfer systems 100 used to provide electronic advertising or other content from content providers to client devices, separate data stores may be implemented in data stores server(s) 104 to store listings of available content and descriptions, content usage statistics, client device profiles, account data, network usage statistics, etc.

A user profile data store 411 may include information relating to the end users within the electronic transfer network 100. This information may include user characteristics such as the user names, access credentials (e.g., logins and passwords), user preferences, and information relating to any previous user interactions within the electronic transfer network 100 (e.g., requested data, provided data, system usage data/statistics, associated users, etc.).

An accounts data store 412 may generate and store account data for different users in various roles within the electronic transfer network 100. For example, accounts may be created in an accounts data store 412 for individual end users, administrator users, and external entities such as businesses, governmental or educational institutions. Account data may include account types, current account status, account characteristics, and any parameters, limits, restrictions associated with the accounts.

A content/security credential data store 413 may include access rights and security information for the electronic transfer network 100 and specific files/content resources. For example, the content/security credential data store 413 may include login information (e.g., user identifiers, logins, passwords, etc.) that can be verified during login attempts by users and/or client devices 106 to the network 100. The content/security credential data store 413 also may be used to store assigned user roles and/or user levels of access. For example, a user's access level may correspond to the sets of data and/or the client or server applications that the user is permitted to access. Certain users and/or client devices may be permitted or denied access to certain applications and resources based on their access level, subscription level, etc. Certain users and/or client devices 106 may have supervisory access over one or more end users accounts and/or other client devices 106, allowing the supervisor to access all or portions of the user's content access, activities, etc. Additionally, certain users and/or client devices 106 may have administrative access over some users and/or some applications in the electronic transfer network 100, allowing such users to add and remove user accounts, modify user access permissions, perform maintenance updates on software and servers, etc.

A content library data store 414 may include information describing the individual data items (or resources) available via the electronic transfer network 100. In some embodiments, the content data store 414 may include metadata, properties, and other characteristics associated with the data items stored in the content server 112. Such data may identify one or more aspects or attributes of the associated data items, for example, subject matter or access level of the content resources, license attributes of the data items (e.g., any limitations and/or restrictions on the licensable use and/or distribution of the data items), price attributes of the data items (e.g., a price and/or price structure for determining a payment amount for use or distribution of the data items), language and geographic associations with the data items, and the like. In some embodiments, the content data store 414 may be configured to allow updating of data item metadata or properties, and to allow the addition and/or removal of information relating to the data items. For example, item relationships may be implemented as graph structures, which may be stored in the content data store 414 or in an additional data store for use by selection algorithms along with the other metadata.

In addition to the illustrative data stores described above, data store server(s) 104 (e.g., database servers, file-based storage servers, etc.) may include one or more external data aggregators 415. External data aggregators 415 may include third-party data sources accessible to the electronic transfer network 100, but not maintained by the electronic transfer network 100. External data aggregators 415 may include any electronic information source relating to the users, data items, or applications of the electronic transfer network 100. For example, external data aggregators 415 may be third-party data stores containing demographic data, education related data, financial data, consumer sales data, health related data, and the like. Illustrative external data aggregators 415 may include, for example, social networking web servers, public records data stores, educational institution servers, business servers, consumer sales data stores, medical record data stores, etc. Data retrieved from various external data aggregators 415 may be used to verify and update user account information, suggest or select user content, and perform user and content evaluations. In some cases, external data aggregators 415 may correspond to external servers/systems 110.

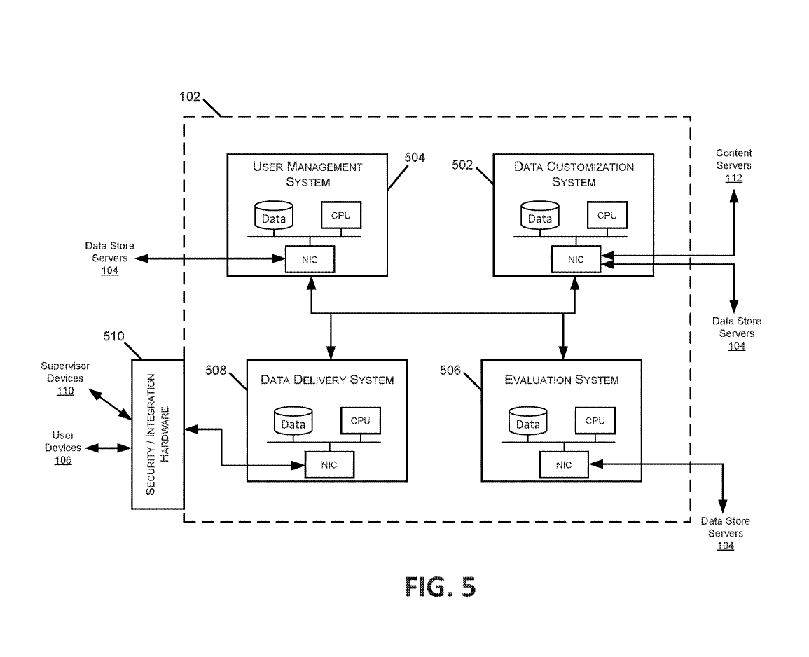

With reference now to FIG. 5, a block diagram is shown illustrating an embodiment of one or more data management servers 102 within an electronic transfer network 100. As discussed above, data management server(s) 102 may include various server hardware and software components that manage the content resources within the electronic transfer network 100 and provide interactive and adaptive content to users on various client devices 106. For example, data management server(s) 102 may provide instructions to and receive information from the other devices within the electronic transfer network 100, in order to manage and transmit data resources, user data, and server or client applications executing within the network 100.

A data management server 102 may include a data customization system 502. The data customization system 502 may be implemented using dedicated hardware within the electronic transfer network 100 (e.g., a data customization server 502), or using designated hardware and software resources within a shared data management server 102. In some embodiments, the data customization system 502 may adjust the selection and adaptive capabilities of data resources to match the needs and desires of the users and/or client devices 106 receiving the content. For example, the data customization system 502 may query various data stores and servers 104 to retrieve user information, such as user preferences and characteristics (e.g., from a user profile data store 411), location/geographic information associated with users and/or client devices 106, user access restrictions to data recourses (e.g., from an access credential data store 413), previous user activity within the network 100, and the like. Based on the retrieved information from data stores 104 and other data sources, the data customization system 502 may modify content resources for individual users and/or individual client devices 106.

A data management server 102 also may include a user management system 504. The user management system 504 may be implemented using dedicated hardware within the electronic transfer network 100 (e.g., a user management server 504), or using designated hardware and software resources within a shared data management server 102. In some embodiments, the user management system 504 may monitor the activities of users and/or user devices 106 with respect to various data resources. For example, the user management system 504 may query one or more databases and/or data store servers 104 to retrieve user data such as associated data resources, access and completion status, results, and the like.

A data management server 102 also may include an evaluation system 506. The evaluation system 506 may be implemented using dedicated hardware within the electronic transfer network 100 (e.g., an evaluation server 506), or using designated hardware and software resources within a shared data management server 102. The evaluation system 506 may be configured to receive and analyze information from client devices 106. For example, various data received by users via client devices 106 may be compiled and analyzed, and then stored in a data store 104 associated with the user and/or data item. In some embodiments, the evaluation server 506 may analyze the information to determine the effectiveness or appropriateness of a data resources with a user or user group, for example, based on subject matter, age group, skill level, or the like. In some embodiments, the evaluation system 506 may provide updates to the data customization system 502 or the user management system 504, with the attributes of one or more data resources or groups of resources within the network 100.

A data management server 102 also may include a data delivery system 508. The data delivery system 508 may be implemented using dedicated hardware within the electronic transfer network 100 (e.g., a data delivery server 508), or using designated hardware and software resources within a shared data management server 102. The data delivery system 508 may receive data from the data customization system 502 and/or from the user management system 504, and transmit the resources to client devices 106. In some embodiments, the data delivery system 508 may determine the appropriate presentation format for the data resources based on the user characteristics and preferences, and/or the device capabilities of client devices 106. If needed, the data delivery system 508 may convert the content resources to the appropriate presentation format and/or compress the content before transmission. In some embodiments, the data delivery system 508 may also determine the appropriate transmission media and communication protocols for transmission of the data to and from client devices 106.

In some embodiments, the data delivery system 508 may include specialized security and integration hardware 510, along with corresponding software components to implement the appropriate security features for data transmission and storage, to provide the supported network and client access models, and to support the performance and scalability requirements of the network 100. The security and integration layer 510 may include some or all of the security and integration components 308 discussed above in FIG. 3, and may control the transmission of data, as well as the receipt of requests and data interactions, to and from the client devices 106, external servers 110, administrative servers 116, and other devices in the network 100.

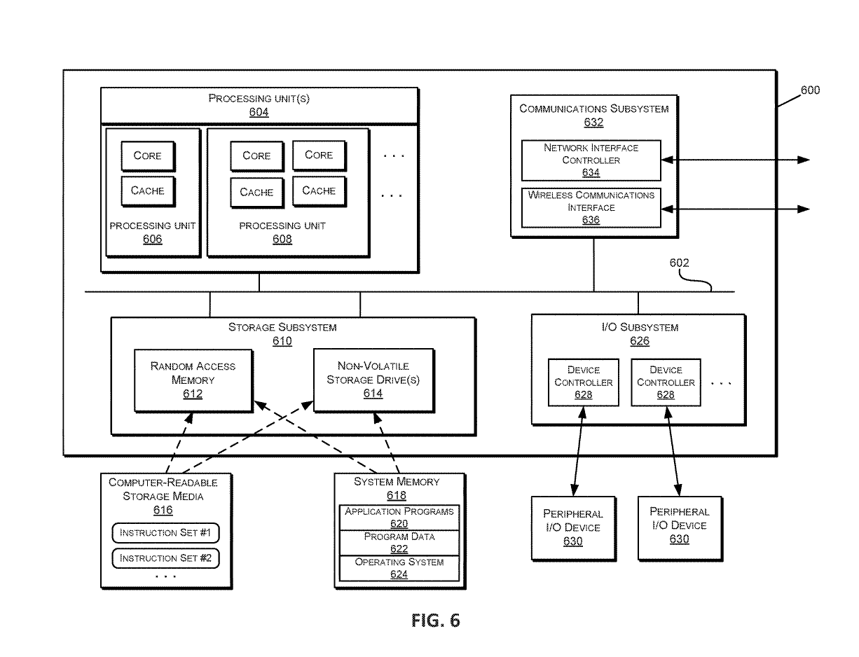

With reference now to FIG. 6, a block diagram of an illustrative computer system is shown. The system 600 may correspond to any of the computing devices or servers of the electronic transfer network 100 described above, or any other computing devices described herein. In this example, computer system 600 includes processing units 604 that communicate with a number of peripheral subsystems via a bus subsystem 602. These peripheral subsystems include, for example, a storage subsystem 610, an I/O subsystem 626, and a communications subsystem 632.

Bus subsystem 602 provides a mechanism for letting the various components and subsystems of computer system 600 communicate with each other as intended. Although bus subsystem 602 is shown schematically as a single bus, alternative embodiments of the bus subsystem may utilize multiple buses. Bus subsystem 602 may be any of several types of bus structures including a memory bus or memory controller, a peripheral bus, and a local bus using any of a variety of bus architectures. Such architectures may include, for example, an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 604, which may be implemented as one or more integrated circuits (e.g., a conventional microprocessor or microcontroller), controls the operation of computer system 600. One or more processors, including single core and/or multicore processors, may be included in processing unit 604. As shown in the figure, processing unit 604 may be implemented as one or more independent processing units 606 and/or 608 with single or multicore processors and processor caches included in each processing unit. In other embodiments, processing unit 604 may also be implemented as a quad-core processing unit or larger multicore designs (e.g., hexa-core processors, octo-core processors, ten-core processors, or greater. As discussed above, in some cases, processing unit 604 may include one or more specialized ASICs designed and configured for cryptocurrency mining and/or specialized cryptographic hardware for handling cryptocurrency transactions.

Processing unit 604 may execute a variety of software processes embodied in program code, and may maintain multiple concurrently executing programs or processes. At any given time, some or all of the program code to be executed can be resident in processor(s) 604 and/or in storage subsystem 610. In some embodiments, computer system 600 may include one or more specialized processors, such as digital signal processors (DSPs), outboard processors, graphics processors, application-specific processors, and/or the like.

I/O subsystem 626 may include device controllers 628 for one or more user interface input devices and/or user interface output devices 630. User interface input and output devices 630 may be integral with the computer system 600 (e.g., integrated audio/video systems, and/or touchscreen displays), or may be separate peripheral devices which are attachable/detachable from the computer system 600.

Input devices 630 may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. Input devices 630 may also include three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additional input devices 630 may include, for example, motion sensing and/or gesture recognition devices that enable users to control and interact with an input device through a natural user interface using gestures and spoken commands, eye gesture recognition devices that detect eye activity from users and transform the eye gestures as input into an input device, voice recognition sensing devices that enable users to interact with voice recognition systems through voice commands, medical imaging input devices, MIDI keyboards, digital musical instruments, and the like.

Output devices 630 may include one or more display subsystems, indicator lights, or non-visual displays such as audio output devices, etc. Display subsystems may include, for example, cathode ray tube (CRT) displays, flat-panel devices, such as those using a liquid crystal display (LCD) or plasma display, light-emitting diode (LED) displays, projection devices, touch screens, and the like. In general, use of the term “output device” is intended to include all possible types of devices and mechanisms for outputting information from computer system 600 to a user or other computer. For example, output devices 630 may include, without limitation, a variety of display devices that visually convey text, graphics and audio/video information such as monitors, printers, speakers, headphones, automotive navigation systems, plotters, voice output devices, and modems.

Computer system 600 may comprise one or more storage subsystems 610, comprising hardware and software components used for storing data and program instructions, such as system memory 618 and computer-readable storage media 616. The system memory 618 and/or computer-readable storage media 616 may store program instructions that are loadable and executable on processing units 604, as well as data generated during the execution of these programs.

Depending on the configuration and type of computer system 600, system memory 618 may be stored in volatile memory (such as random access memory (RAM) 612) and/or in non-volatile storage drives 614 (such as read-only memory (ROM), flash memory, etc.) The RAM 612 may contain data and/or program modules that are immediately accessible to and/or presently being operated and executed by processing units 604. In some implementations, system memory 618 may include multiple different types of memory, such as static random access memory (SRAM) or dynamic random access memory (DRAM). In some implementations, a basic input/output system (BIOS), containing the basic routines that help to transfer information between elements within computer system 600, such as during start-up, may typically be stored in the non-volatile storage drives 614. By way of example, and not limitation, system memory 618 may include application programs 620, such as client applications, Web browsers, mid-tier applications, server applications, etc., program data 622, and an operating system 624.

Storage subsystem 610 also may provide one or more tangible computer-readable storage media 616 for storing the basic programming and data constructs that provide the functionality of some embodiments. Software (programs, code modules, instructions) that when executed by a processor provide the functionality described herein may be stored in storage subsystem 610. These software modules or instructions may be executed by processing units 604. Storage subsystem 610 may also provide a repository for storing data used in accordance with the present invention.

Storage subsystem 300 may also include a computer-readable storage media reader that can further be connected to computer-readable storage media 616. Together and, optionally, in combination with system memory 618, computer-readable storage media 616 may comprehensively represent remote, local, fixed, and/or removable storage devices plus storage media for temporarily and/or more permanently containing, storing, transmitting, and retrieving computer-readable information.

Computer-readable storage media 616 containing program code, or portions of program code, may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 600.

By way of example, computer-readable storage media 616 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 616 may include, but is not limited to, Zip® drives, flash memory cards, universal serial bus (USB) flash drives, secure digital (SD) cards, DVD disks, digital video tape, and the like. Computer-readable storage media 616 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 600.

Communications subsystem 632 may provide a communication interface from computer system 600 and external computing devices via one or more communication networks, including local area networks (LANs), wide area networks (WANs) (e.g., the Internet), and various wireless telecommunications networks. As illustrated in FIG. 6, the communications subsystem 632 may include, for example, one or more network interface controllers (NICs) 634, such as Ethernet cards, Asynchronous Transfer Mode NICs, Token Ring NICs, and the like, as well as one or more wireless communications interfaces 636, such as wireless network interface controllers (WNICs), wireless network adapters, and the like. Additionally and/or alternatively, the communications subsystem 632 may include one or more modems (telephone, satellite, cable, ISDN), synchronous or asynchronous digital subscriber line (DSL) units, FireWire® interfaces, USB® interfaces, and the like. Communications subsystem 636 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

The various physical components of the communications subsystem 632 may be detachable components coupled to the computer system 600 via a computer network, a FireWire® bus, or the like, and/or may be physically integrated onto a motherboard of the computer system 600. Communications subsystem 632 also may be implemented in whole or in part by software.

In some embodiments, communications subsystem 632 may also receive input communication in the form of structured and/or unstructured data feeds, event streams, event updates, and the like, on behalf of one or more users who may use or access computer system 600. For example, communications subsystem 632 may be configured to receive data feeds in real-time from users of social networks and/or other communication services, web feeds such as Rich Site Summary (RSS) feeds, and/or real-time updates from one or more third party information sources (e.g., data aggregators 309). Additionally, communications subsystem 632 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 632 may output such structured and/or unstructured data feeds, event streams, event updates, and the like to one or more data stores 104 that may be in communication with one or more streaming data source computers coupled to computer system 600.

Due to the ever-changing nature of computers and networks, the description of computer system 600 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

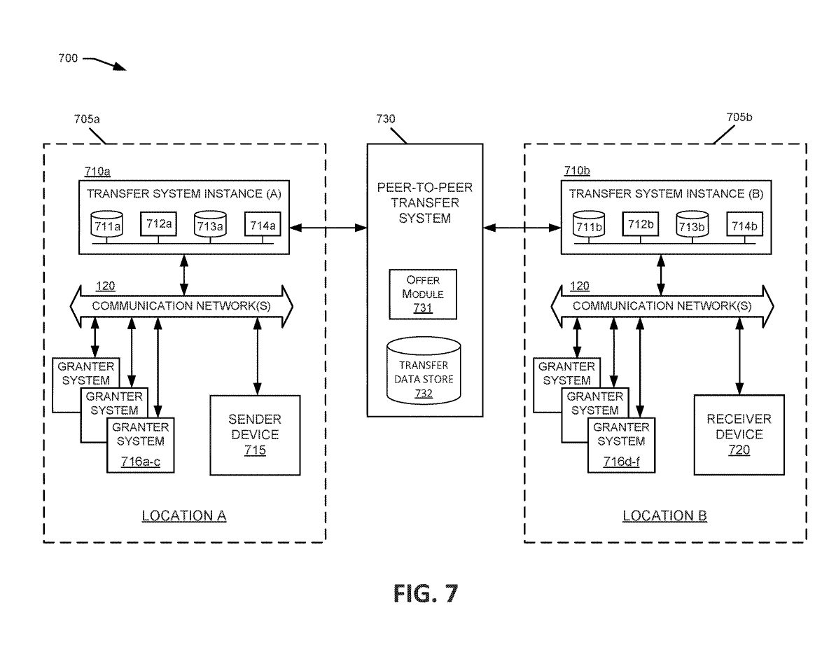

With reference now to FIG. 7, a block diagram is shown illustrating an example transfer system 700 configured to support transfers between sender devices 715 in one location 705a and receiver devices 720 in another location 705b. As shown in this example, certain embodiments may support transfers between locations 705a and 705b using a peer-to-peer transfer system 730 and/or separate transfer instances 710a and 710b operating respectively at locations 705a and 705b. In various embodiments, locations 705 may correspond to different physical or virtual domains/regions, for instance, different geographic areas within different jurisdictions, different data centers, different networks, different computing infrastructures, etc. Additionally, certain transfers may be performed based on data receivers from granter systems 716a-f operating within one or both of the locations 705a and 705b.

As described herein, transfers between a sender and receiver may refer to transfers of various different types of data items (e.g., files, database records, media or other content resources, etc.), as well as other secure data transactions or other interactions between a sender device 715 and a receiver device 720. In some embodiments, the transfer system 700 may be configured to operate as a value transfer system by which users at sender devices 715 within a first location 705a may initiate value transfers to users at receiver devices 720 within a second location 705b. In such cases, granter systems 716 may correspond to lender systems operated by financial institutions or any other value lender system. As discussed below, granter systems 716 may be used in such embodiments to provide offers for advances (e.g., loans) based on the sender's credentials (e.g., credit score, risk assessment value, authorization limits, etc.), the receiver's credentials, and/or combinations of sender and receiver credentials, in order to enable immediate value transfers between senders and receivers when the requested amount to be transferred is not immediately available in the sender's accounts. Different locations 705 may correspond to different geographic areas and/or different jurisdictions where different lending and value transfer rules may apply. Thus, in such embodiments, transfer system 700 may be applied to applied to transfers of currency, or any other medium of exchange (e.g., credit, gift cards or certificates, points in a user point system, etc.), between users in different areas, regions, or jurisdictions.

In other embodiments, the transfer system 700 may be configured to perform other types of multi-party data transfers and/or secure transactions, such as transfers of data items including secure files, records, and/or content resources, from a sender device 715 in one location 705a to a receiver device 720 in another location 705b. In such embodiments, the locations 705a and 705b may correspond to different geographic areas and/or different computing infrastructures (e.g., different data centers, different networks, etc.) over which the secure electronic transfer may be performed. Granter systems 716, in such embodiments, may correspond to authentication systems, data access/permission systems, subscription monitor systems, network access providers, and/or any other servers that may be used to monitor, permit/deny access, and/or enable data transfers. In still other implementations, transfer systems 700 may be implemented as part of interactive gaming systems, educational and profession training systems, and/or social network systems, to enable the transfer of certain data or values (e.g., points, credits, resources, etc.) between system users in different locations 705.

As discussed in more below detail, sender devices 715 and/or receiver devices 720 in various implementations of transfer systems 700 may be configured to interact with users by receiving input via I/O subsystems corresponding to transfer requests, authentication credentials, and selections of qualifying offers for performing transfers. Sender devices 715 and receiver devices 720 may interact with transfer systems 710a and 710b, respectively, via the communication networks 120 and computing infrastructures available at their locations 705a and 705b. The transfer system 700 may include one or more transfer servers, which may be implemented as multiple transfer system instances 710a and 710b executing in separate locations 705a and 705b, as a single central transfer system 730 which need not (but may) operate in either location 705a and 705b, or as a combination of transfer system instances 710 and a central transfer system 730. As discussed below, these transfer server(s) 710 and 730 may, among other things, receive transfer requests from sender devices 715 and/or receiver devices 720, receive and/or determine sender credentials and receiver credentials associated with the requested transfer, receive and analyze offers from granter systems 716 based on the sender and/or receiver credentials applicable to the requested transfer, and determine combinations of qualifying offers to perform the requested transfer.

In order to perform these features and other functionality described herein, each of the components and sub-components discussed in the example transfer system 700 may correspond to a single computer server or a complex computing system including a combination of computing devices, storage devices, network components, etc. Each of these components and their respective subcomponents may be implemented in hardware, software, or a combination thereof. In some cases, sender devices 715, receiver devices 720, and various granter systems 716 may communicate directly with the transfer system instances 710 and/or central transfer server 730, while other devices 715-720 may communicate with the transfer system instances 710 and/or central server 730 indirectly via one or more intermediary network components (e.g., routers, gateways, firewalls, etc.) or other devices (e.g., data management servers 102, content servers 112, etc.). Although the physical network components have not been shown in this figure so as not to obscure the other elements depicted in the figure, it should be understood that any of the network hardware components and network architecture designs may be implemented in various embodiments to support communication between the servers and devices in the system 700. Additionally, different devices 715-720 may use different networks and networks types to communicate with the transfer system instances 710 and/or server 730, including one or more telecommunications networks, cable networks, satellite networks, cellular networks and other wireless networks, and computer-based IP networks, and the like. Further, certain components within transfer system 700 may include special purpose hardware devices and/or special purpose software, such as those included in I/O subsystems systems, positioning systems, and storage and networking capabilities of the sender and receiver devices 715 and 720, as well as those within the processing engines and data stores 711-714 of the transfer system instances 710, and processing engines and data stores 731-732 of the peer-to-peer transfer system 730, discussed below.

In some embodiments, a transfer system 700 may be integrated within, or configured to operate in collaboration with, one or more electronic transfer networks 100. For example, system 700 may be the same as, or may operate within or in collaboration with, any of the electronic transfer network 100 described above. Thus, specific examples of transfer systems 700 may include, without limitation, secure systems for transferring value and other media of exchange, multi-entity systems for exchanging content resources (e.g., media files, educational and professional training content, gaming content, Internet content, etc.), and other electronic transfer systems. In such cases, the peer-to-peer transfer system 730 and/or one or more of the transfer system instances 710 may correspond to and may be implemented within a data management server 102 and/or a data store server 104, and sender and receiver devices 715 and 720 may correspond to the client devices described above in reference to network 100. Thus, within system 700, sender and receiver devices 715 and 720 may request and receive data from the peer-to-peer transfer system 730 (e.g., via one or more transfer system instances 710), may execute and/or display the data received data, and then may transmit various user responses/interaction data back the peer-to-peer transfer system 730 (e.g., via one or more transfer system instances 710). In other examples, the peer-to-peer transfer system 730 and/or transfer system instances 710 may be implemented using one or more computer servers, and other specialized hardware and software components, separately from other the components of an associated network 100, such as content servers 112, data management servers 102, data store servers 104, and the like. In these examples, the peer-to-peer transfer system 730 and/or transfer system instances 710 may be configured to communicate directly with sender and receiver devices 715 and 720 and external granter systems 716, or indirectly through data management servers 102 and/or other components and communications networks of the network 700.

As noted above, the sender device 715 and receiver device 720 in this example may include any of the types of client devices 106 discussed above. For example, the sender device 715 and/or receiver device 720 may be a laptop computer, smartphone, tablet computer, or various other type of mobile device, each of which may include some or all of the hardware, software, and networking components discussed above. Sender device 715 and/or receiver device 720 also may be a digital kiosk device 206 including one or more of the additional components/features discussed above. Specifically, the sender device 715 and receiver device 720 may be any computing device with sufficient memory, processing, and I/O subcomponents for initiating and/or presenting transfer requests from the client side. Accordingly, sender device 715 and/or receiver device 720 may include the necessary hardware and software components to establish the network interfaces, security and authentication capabilities, and data caching capabilities to initiate and receive transfer requests, and receive and provide data to users in real-time or near real-time. Moreover, in certain embodiments, sender devices 715 and/or receiver devices 720 may include digital positioning systems 219 (e.g., GPS receivers) or other location determination systems to detect and transmit device location data that may be used to match offers from granter systems 716 applicable to that location 705. In some cases, a certain sender device 715 or receiver device 720 may change between locations 705a-705b over time, including changes in physical/geographic locations, as well as changes to its computing infrastructure (e.g., changes in network access or availability, changes in data centers or supporting hardware layers, etc.).

Granter systems 716 may correspond to external servers/systems 110 or any other computing systems configured to communicate offer data with component transfer system instances 710, central transfer system servers 730, and/or sender and receiver devices 715 and 720 via various communication networks 120. Granter systems 716 may communicate offer data to component transfer system instances 710, central transfer system servers 730, and/or sender and receiver devices 715 directly or indirectly via one or more intermediary network components (e.g., routers, gateways, firewalls, etc.) or other devices (e.g., data management servers 102, content servers 112, etc.). As discussed below in more detail, the offer data provided by granter systems 716 may correspond to advance offers from financial institutions or other lender systems. In other examples, the offer data provided by granter systems 716 may correspond to data resource authentication or access credential requirements, network usage offers or requirements, data resource subscription offers or requirements, etc. Thus, granter systems 716 in various embodiments may correspond to financial institutions, network authentication and access systems, content subscription systems, and various other types of systems that may be used to monitor transfers, permit or deny transfers, and/or enable transfers any of the various examples described herein.

Additionally, as shown in this example, certain granter systems 716 may be associated with specific corresponding locations. For instance, granter systems 716a-716c may be associated with Location A 705a, while granter systems 716d-716f may be associated with Location B 705b. In such cases, the offers provided by granter systems may be applicable to their associated locations, but might not applicable to other locations. As an example with respect to value transfers, a first granter system 716a for a lender may provide advance offers applicable only to users within a specific jurisdiction or domain 705a, and a second granter system 715d associated with the same or a different lender may provide advance offers applicable only to users within a different jurisdiction or domain 705b. In other examples, offers may correspond to offers for network access and bandwidth, offers for available computing resources (e.g., memory, hosts, processors, etc.), and the different granter systems 716 provide offers applicable to different computing domains, infrastructures, environments, etc. As shown in this example, in some cases granter systems 716 may themselves operate within their associated locations 705. However, in other examples, granter systems 716 need not be located within their associated locations 705, but may operate in a separate location (e.g., a different domain, a different jurisdiction, etc.) and may nonetheless provide offers applicable a specific location 705a or 705b.

A peer-to-peer (P2P) transfer system 730, operating alone or in conjunction with a network of transfer system instances 710, may communicate with sender devices 715, receiver devices 720, and granter systems 716 within the transfer system 700. As discussed below in more detail, the P2P transfer system 730 and/or transfer system instances 710 may be deployed and configured to receive and handle transfer requests from sender and receiver devices 715 and 720, receive/determine sender credentials and receiver credentials associated with requested transfers, receive and analyze offers from granter systems 716 based on sender and/or receiver credentials, and determine combinations of qualifying offers for requested transfers. In some embodiments, after determining one or more qualifying offer combinations for a requested transfer, these systems also may transmit the determine combination(s) to the appropriate sender device(s) 715 and receiver device(s) 720, receive responses from the sender and/or receiver device (e.g., accepting or rejecting a combination, selecting a preferred combination, etc.), and then initiating the transfer using a selected qualifying offer combination.

As shown in this example, a transfer system 700 may be implemented with a peer-to-peer transfer system 730 in communication with a network of transfer system instances 710. In such embodiments, the P2P transfer system 730 may be implemented as a central transfer server 730 which need not (but may) operate within any of the locations 705 in the system 700. The P2P transfer system 730 may receive and analyze sender data, receiver data, device data, and data from granter systems 716 from a plurality of transfer system instances 710. Each transfer system instance 710 may be implemented as a transfer server 710 located within and/or associated with a designated location 705. In this example, transfer system instance 710a communicates with sender device 715 (and any other sender and/or receiver devices within location 705a) and receives granter data and offer data from granter systems 716a-716c, while transfer system instance 710b communicates with receiver device 720 (and any other sender and/or receiver devices within location 705b) and receives granter data and offer data from granter systems 716d-716f. Both transfer instances 710 may communicate transfer request data, sender and/or receiver data, granter and/or offer data to the peer-to-peer transfer system 730.

In some embodiments, peer-to-peer transfer system 730 may be the central processing engine of the system 700. As shown in this example, the P2P transfer system 730 may include an offer module 731 configured to store and analyze offers from various granter systems 716 in relationship to requested transfers. Additionally or alternatively, P2P transfer systems 730 may collaborate with the transfer instances 710 to handle requested transfers, determine qualifying offer combinations, etc. For example, in some embodiments, each transfer system instance 710 may include one or more data stores 711 for receiving and storing sender/receiver data, an enrollment module 712 configured to handle sender, receiver, and granter enrollments into the system, one or more granter/offer data stores 713 configured to receive and store granter information and offers received from granter systems 716 associated with the location 705, and an offer settlement module 714 configured to coordinate granter systems 716 and sender/receiver devices 715 after a combination of offers has been determined and accepted.

In some embodiments, transfer systems 700 need not include both a central P2P transfer system 730 and individual transfer system instances 710, but may be implemented with either one or the other to performing the request handling and other functionality described herein. For example, in some transfer systems 700, sender devices 715, receiver devices 720, and granter systems 716 may communicate directly with a central transfer server 730 within an intermediary transfer system instance 710. As another example, a transfer system 700 having a plurality of transfer system instances 710 for corresponding locations 705 may communicate directly with one another, without any central P2P transfer system 730. Additionally, although this example shows only two locations 705a and 705b with two corresponding transfer system instances 710a and 710b, it should be understood that any number of different locations 705 and transfer system instances 710 may be implemented in other examples. Further, as noted above, locations 705 may correspond to specific physical/geographic regions (e.g., countries, jurisdictions, physical domains, etc.), or to computing locations (e.g., specific data centers, networks, network domains, etc.). Locations 705 also may correspond to unique combinations of physical regions and “virtual regions” (e.g., specific computing infrastructures, networks, etc.). For instance, a location 705a may include all of the sender/receiver devices 715 and 720, and granter systems 716 within a country (or other jurisdiction) that access the system 700 via a specified communication medium, network type, and/or client software application.

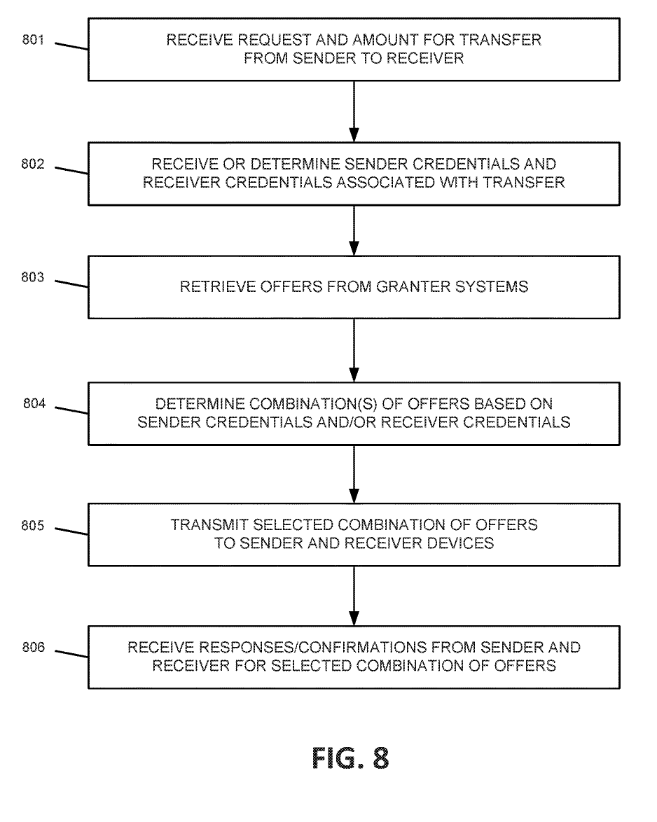

Referring now to FIG. 8, a flow diagram is shown illustrating an example process of determining and presenting one or more combinations of the offers received from granter systems, in response to a received transfer request. As described below, the steps in this process may be performed by one or more components in the transfer system 700 described above, such as the sender and receiver devices 715 and 720, transfer system instances 710 for locations 705, and P2P transfer system 730. However, it should be understood that the various features and processes described herein, including receiving transfer requests from sender devices 715 and/or receiver devices 720, receiving and analyzing offers from granter systems 716, and determining combinations of qualifying offers based on sender and/or receiver credential data, need not be limited to the specific systems and hardware implementations described above in FIGS. 1-7.

In step 801, one or more components of the transfer system 700 may receive data identifying a transfer request between one or more senders and one or more receivers. In some embodiments, transfer requests may be initiated by users via sender devices 715 and/or receiver devices 720, received may transfer system instances 710, and forwarded to P2P transfer system 730. For example, a sender user may login and authenticate via a mobile device, personal computer, or specialized digital kiosk, and identify one or more transfer recipients. As discussed above, the requested transfer may correspond to a value transfer of financial assets or other media of exchange. In such cases, a requested value transfer amount may be included in the request data. For instance, a sender in Location A 705a may use sender device 715 to initiate a transfer of N amount (e.g., expressed in dollars, another currencies, or any other medium of exchange), to a recipient user in Location B 705b. To complete the transfer, the sender may use value/assets from the sender's various authorized accounts (e.g., bank accounts, credit accounts, debit accounts, financial asset accounts, reward points accounts, etc.), as well as other financial sources. The sender also may present value/assets in person (e.g., in cash or with other exchangeable currency) at a point-of-sale sender device 715, value transfer kiosk sender device 715, or transfer agent office sender device 715, in order to complete the transfer. However, in some cases, the sender may be unable to fully complete a requested transfer immediately at the time of the request in step 801. For example, the sender's accounts may lack the requested amounts (e.g., maxed out cards, unavailable credit lines, etc.), and/or certain value from the sender's accounts might not be immediately accessible for withdrawal and transfer to the receiver. As described below, granter systems 716 such as financial institutions and other value lending entities may be used in such cases to provide or guarantee the amounts for the requested transfer.

Although the above example describes a transfer request that may be received in step 801, it should be understood that the various transfer systems 700 and other techniques described herein may support other types of requested transfers between senders and receivers. For example, certain transfer systems 700 may be configured to support other multi-party data transfers and/or secure transactions (e.g., secure file transfers, record transfers, media/content resource transfers, etc.). Additionally, in other examples, the requested transfers between senders and receivers may correspond to transfers of virtual data items (e.g., points, credits, resources, etc.) between users in interactive gaming systems, educational and profession training systems, social network systems, and the like. Thus, the request received in step 801 may identify any of these types of transfers, along with the associated sender(s) and receiver(s), and the items/amounts to be transferred. Accordingly, the granter systems 716 in such embodiments need not be financial institutions or lender systems, but instead may correspond to user authentication systems, data access/permission systems, subscription monitor systems, network access providers, and/or any other servers that may be used to monitor, permit and deny access, and/or enable the requested transfers.

In step 802, a sender credentials and receiver credentials may be received or determined in connection with the transfer request received in step 801. The type of sender and receiver credentials may depend on the type of requested transfer. For example, for value transfers, the relevant sender and receiver credentials may correspond to user credit scores, risk assessment values or risk scores, credit limits, authorized advance limits, and the like. Other types of transfers may have other types of relevant sender and receiver credentials, such as computing infrastructure usage limits, bandwidth restrictions, resource transfer limits, etc. In some cases, the relevant sender and receiver credentials may be received along with the transfer request in step 801. In other cases, the transfer system instances 710 and/or P2P transfer system 730 may retrieve the sender and receiver credentials, for example, from sender/receiver data stores 711, transfer data stores 732, or from various external third-party systems 110 connected to the transfer system via communication networks 120.

In step 803, transfer system instances 710 and/or P2P transfer system 730 may retrieve offers from various granter systems 716. For embodiments in which the requested transfer is a transfer of value/assets or other medium of exchange, the offers received from granter systems 716 may correspond to advance offers from lender systems 716. In some examples, an advance offer may include an advance value/amount, a credential threshold requirement, and an associated set of terms. In other embodiments, the offers received from granter systems 716 in step 803 may correspond to offers for various other resources, such as offers for use of computing resources and/or network resources that may be used to perform a requested data transfer, offers for providing access to specific content resources (e.g., media files), or offers for virtual resources to be provided and used within gaming systems, social networking systems, etc.

Each granter system 716 may provide one offer or several offers, each offer having an associated amount, credential threshold, and/or set of terms related to the offer. Additionally, certain offers may be applicable only to certain locations 705. For example, first granter system 716a may provide offers applicable only to users within Location A 705a, and/or to transfers into or out of Location A 705a. Such limitations and customizations of offers may be used to implement jurisdictional rules (e.g., value transfer rules), or to provide customized offers for different computer domains, networks, computing infrastructures or environments, etc.

In some embodiments, various granter systems 716 may provide offers in advance, before the transfer request is received in step 801, which may be stored by transfer system instances 710 and/or P2P transfer system 730. Such offers may be received and stored within the storage systems of the transfer system instances 710 (e.g., within granter/offer data stores 713) and/or the P2P transfer system 730 (e.g., the transfer data stores 732), and then retrieved from these storage systems in step 803 in response to the received transfer requests in step 801, based on the identified sender and receiver for the requested transfer, and/or other transfer request data.

In step 804, the transfer system instances 710 and/or P2P transfer system 730 may determine one or more combinations of the offers received from granter systems 716 in step 803, which may be used to perform the transfer requested in step 801. In some embodiments, each combination of offers determined in step 804 may be identified based on a determination that the aggregated amounts/values associated with each of the offers in a combination are sufficient to satisfy the amount of the requested transfer. For instance, in examples involving value transfer requests, the offer combinations determined in step 804 may include one or more advance offers from granter systems 716, that when aggregated, are greater than or equal to the requested advance amount of the transfer received in step 801. In examples involving transfers of data or other resources, the items, amounts, and values (e.g., computing resources, network access, virtual data items, etc.) associated with each offer may be aggregated and compared to the amount requested by the transfer request. Additionally, every individual offer in an offer combination may be separately evaluated to confirm that the offer is a qualifying offer with respect to the sender, receiver, transfer locations, and/or other data relating to the requested transfer. For example, an offer may have an associated threshold value (e.g., a credential threshold) that may be compared to the sender credentials and/or receiver credentials to determine if the requested sender-to-receiver transfer is qualified to use the offer. In some cases, every individual offer in an offer combination must be a qualifying offer in order to be included in a combination.

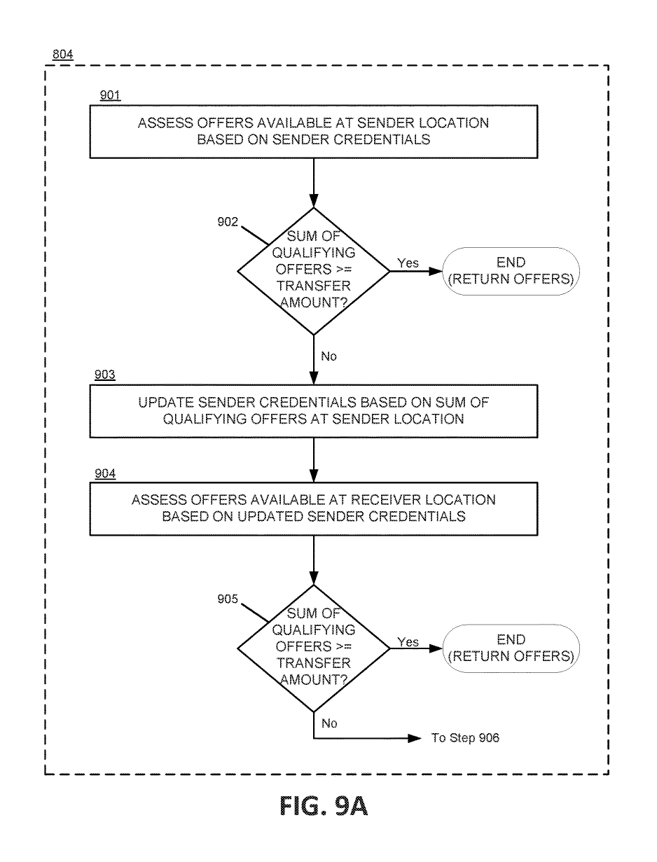

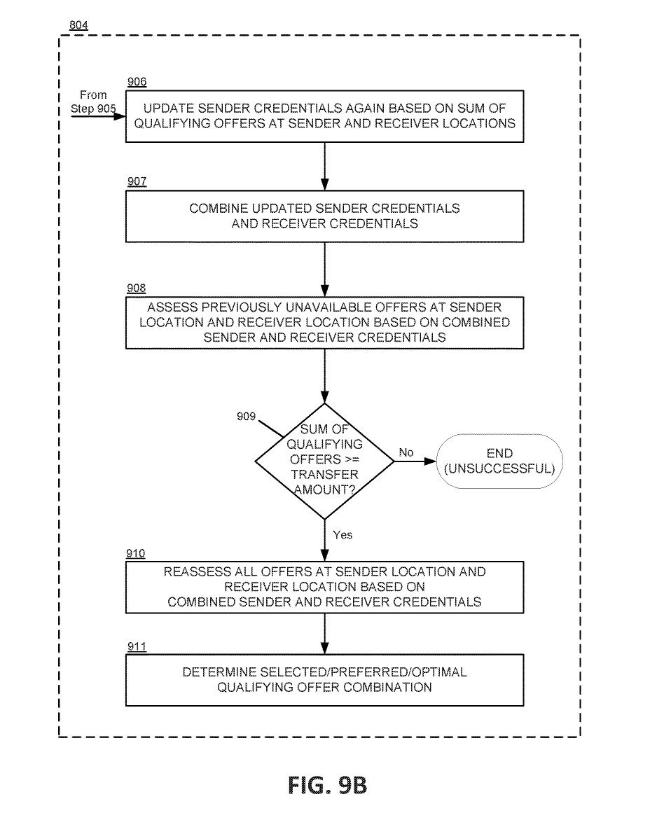

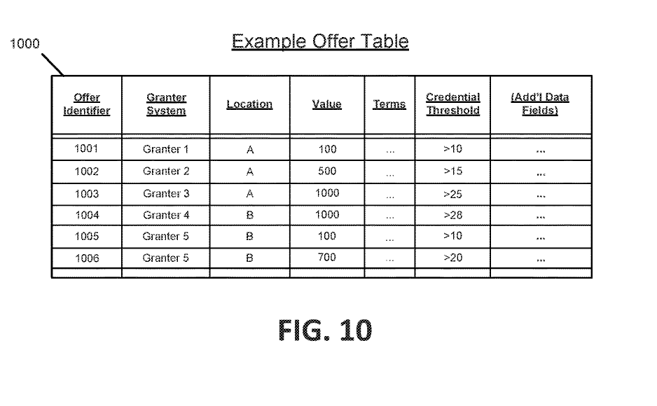

Different possible offer combinations determined in step 804 may include, for example, a set of one or more offers received from a single granter system 716, a set of multiple offers received from multiple different granter systems (e.g., 716a-716c) associated with the same location (e.g., 705a), or a set of multiple offers received from multiple different granter systems (e.g., 716a-716f) associated with different locations (e.g., 705a and 705b). Additionally, the evaluation of offers to determine qualifying combinations of offers may be based on the sender's credentials alone, the receiver's credentials alone, or a combination of sender's and receiver's credentials. For instance, a detailed example of determining a qualifying combination of advance offers to use for a value transfer request, based on combined sender and receiver credentials, is discussed below in reference to FIGS. 9A, 9B, and 10.

In step 805, the combination(s) of offers determined in step 804 to perform the requested transfer may be transmitted to the sender device 715 and/or the receiver device 720. In some embodiments, one or both parties to the transfer may review and confirm/approve of the qualifying offer combination before initiating the transfer using the combination. For example, in determined combinations of qualifying advance offers for value transfer requests, the associated sender(s) and receiver(s) may be required to review and assent to the terms and conditions of each individual advance offer in the determined offer combination. In various other examples, only one of the sender or receiver, or neither the sender nor the receiver, might be required to confirm or approve the qualifying offer combination.

In step 806, responses may be received from the sender device 715 and/or the receiver device 720 to the offer combination(s) provided in step 805. In some examples, sender devices 715 and receiver devices 720 may be configured to receive and surface offer combinations via graphical on-screen interfaces, and then receive input from users corresponding to an acceptance or rejection of the offer combination(s). Additionally, in some cases, transfer system instances 710 and/or P2P transfer system 730 may transmit multiple qualifying offer combinations to a sender device 715 and/or receiver device 720 in step 805, and receive input from the sender and receiver selecting one of the qualifying offer combinations to use for the transfer. Thus, senders and receivers may review the offer details and terms/conditions associated with various offer combinations before selecting a preferred qualifying offer combination.

Referring now to FIGS. 9A and 9B (collectively referred to as FIG. 9), another flow diagram is shown illustrating an example process of determining one or more qualifying offer combinations based on combined sender and receiver credentials. The steps discussed below in reference to FIG. 9 may correspond to one particular implementation of the determination of qualifying offer combinations in step 804, discussed above. Thus, the steps in this process also may be performed by the components of transfer system 700 described above, such as the transfer system instances 710 and/or P2P transfer system 730. However, the various features and processes described in reference to FIG. 9 also need not be limited to the specific systems and hardware implementations described above in FIGS. 1-7, but may be performed using other computing systems and environments.

Additionally, the example process of FIG. 9 may be described below in reference to the example offer table 1000 of FIG. 10. As shown in FIG. 10, example offer table 1000 shows six example offers (1001-1006) from five separate granter systems 716. The first three offers in table 1000 are from granter systems 1-3 (e.g., 716a-716c) associated with Location A (e.g., 705a), and the last three offers are granter systems 4-5 (e.g., 716d-716e) associated with Location B (e.g., 705b). Each offer shown in table 1000 also may have an associated offer value (e.g., an advance amount), various offer terms (e.g., interest rate, payment schedule, etc.), and one or more associate credential threshold values (e.g., credit scores, risk scores, etc.) that may be used to determine whether or not the offer is a qualifying offer. Although this example shows only six offers, five granter systems, and two locations, it should be understood that any number of different offers/granters/locations may be represented in various other embodiments. As discussed below, FIGS. 9-10 may illustrate a specific example of determining a combination of qualifying advance offers received from lender systems 716 for a value transfer request. However, as noted above, the transfer systems 700 and various techniques described herein may be used to determining offer combinations from other types of granter systems 716 in connection with requests to transfer data or other types of resources (e.g., computing resources, network access, virtual data items, etc.). Therefore, although the example data shown in table 1000 may be used to illustrate certain features and functionality described herein, it should be understood that the type of data and specific data fields shown in this example are illustrative only and non-limiting.

In step 901, the transfer system instance 710a and/or P2P transfer system 730 may assess a number of offers available at the sender's location 705a. As discussed above, the offers may be received from granter systems 716 (e.g., financial institutions, lenders, etc.) associated with the sender's location 705a. For example, a sender within Location A 705a may request a transfer to a receiver within Location B 705b, but may be unable to fully complete the transfer at the time of the request. Accordingly, the offers assessed in step 901 may correspond to advance offers from various granter systems 716a-716c which may allow the sender to immediately transfer the requested amounts to the receiver. The assessment of the offers in step 901 may be based on a comparison of the sender's credentials to the credential thresholds of the available offers. As discussed above, the sender's credentials may correspond to, for example, a risk rating, credit score, authorization limit, or any other combination of sender data metrics relating to the sender's access permissions, qualifications, and/or risks associated with the requested transfer.

Additionally, in some cases, step 901 may include an initial determination by the transfer system instance 710a and/or P2P transfer system 730 of which offers are available in the sender's location, by evaluating location data received from the sender device 715 to determine the sender's associated location 705a. Various different techniques may be used for determining and evaluating the sender's location, such as receiving location data collected by a GPS receiver or other digital positioning system 219 of the sender device 715, receiving location data input by a user into the sender device 715, analyzing the network addresses and routing paths of the data received from the sender device 715, and the like. In this case, the sender's determined location may correspond to Location A 705a, indicating that offers 1001-1003 are available in Location A (e.g., sender location 705a).

To illustrate this example, assume that the sender's initial risk rating is 12, and that the requested transfer corresponds to an emergency transfer of $950 requested by the sender for the receiver. Additionally, assume that the sender has available value of $150, and thus needs to obtain an advance in the amount of $800 to complete the emergency transfer to the receiver. In such cases, the transfer system instance 710a and/or P2P transfer system 730 may update the sender's initial risk rating based on the available value provided by the sender. For instance, the system may improve the sender's risk rating in response to the sender partially completing the transfer, updating to sender's risk rating to 16.

Continuing this example, the transfer system instance 710a and/or P2P transfer system 730 may compare the sender's updated risk rating (16) to the credential threshold values for each offer (1001-1003) available in the sender's location, thereby determining that the sender is eligible for advance offer 1001 in the amount of $100 and advance offer 1002 in the amount of $500. However, the sender is not eligible for advance offer 1003 because the sender's updated risk rating (16) is still less than the credential threshold (25) for offer 1003.

In step 902, the system 700 (e.g., transfer system instance 710a and/or P2P transfer system 730) may compare the sum of the qualifying offers identified in step 901 to the requested transfer amount. If the qualifying offers available at the sender's location and based only on the sender's credentials are sufficient to cover the requested transfer (902:Yes), then the process may exit and the identified qualifying offers may be returned for review and acceptance by the sender. However, if the sum of the qualifying offers determined in step 901 is less than the requested transfer amount/value (902:No), then the process may continue to step 903. For instance, continuing with the above example, the system 700 may determine in step 902 that the sum of the qualifying advance offers available in the sender's location ($100+$500=$600) is less than the amount ($800) required to fully complete the requested transfer (902:No).

In step 903, the system 700 may further update the sender's credentials to take into account the qualifying offers available at the sender's location 705a. In some cases, the system 700 may assume acceptance of any qualifying offers identified in step 901, and may downgrade the sender's credentials based on the assumed acceptance of these additional obligations. For instance, continuing with the above example, the system 700 may downgrade the sender's risk rating to 11 based on the assumption of the additional sum of $600 owed by the sender to various granter systems 716.

In step 904, the system 700 may access the additional offers available at the receiver's location 705b, using the sender's credentials as updated in step 903. For instance, continuing with the above example, the system 700 may compare the sender's updated risk rating (11) to each offer (1004-1006) associated with the receiver's location 705b. In this case, the system 700 (e.g., transfer system instance 710a and/or P2P transfer system 730) may determine that the sender is eligible for advance offer 1005 in the amount of $100, but is not eligible for advance offers 1004 or 1006, because the sender's updated risk rating (11) is less than the credential thresholds for offers 1004 (28) or 1006 (20).

In step 905, the system 700 may compare the sum of the qualifying offers identified in steps 901 and 904 to the requested transfer amount. If the qualifying offers available at both the sender's and receiver's locations, and based only on the sender's credentials are sufficient to cover the requested transfer (905:Yes), then the process may exit and the identified qualifying offers may be returned for review and acceptance by the sender. However, if the sum of the qualifying offers determined in steps 901 and 904 is less than the requested transfer amount/value (905:No), then the process may continue to step 906. For instance, continuing with the above example, the system 700 may determine in step 905 that the sum of the qualifying advance offers available in the sender's location ($100+$500=$600) plus the sum of the qualifying advance offers available in the receiver's location ($100) is less than the amount ($800) required to fully complete the requested transfer (905:No).

In step 906, the system 700 may once again update the sender's credentials to take into account the qualifying offers available at the receiver's location 705b. Similarly to step 903, discussed above, the system 700 may assume acceptance of any qualifying offers identified in step 905, and may downgrade the sender's credentials based on the assumed acceptance of these additional obligations. For instance, continuing with the above example, the system 700 may downgrade the sender's risk rating from 11 to 10, based on the assumption of the additional sum of $100 owed by the sender to an additional granter system 716.

In step 907, the system 700 may combine the receiver's credentials received in step 802 with the most recently updated sender's credentials to generate a combined sender-receiver credential value. As discussed above, the sender's and receiver's credentials may correspond to data such as risk ratings, credit scores, authorization limits, or any other combination of data metrics relating to the sender's and receiver's access permissions, qualifications, and/or risks associated with the requested transfer. The combination of receiver's credentials and sender's credentials in step 907 may include any of various different techniques, such as averaging, summing, or otherwise combining the receiver's credentials and the updated sender's credentials. In some cases, the underlying data used to generate the individual sender's and receiver's credentials (e.g., income data, account balances, debt data, credit ratings and histories, advance transaction histories, demographic data, etc.) may be combined and/or averaged in order to generate one or more combined credential values. Continuing with the above example, and assuming that the receiver's initial risk rating is 14, the system 700 may add this value to the most recently updated sender's risk rating of 10, to generate a combined risk rating of 24.

In step 908, the system 700 may access the offers available at both the sender's location 705a and the receiver's location 705b, using the combined sender-receiver credentials determined in step 907. It may be noted that, in this example and other similar embodiments, the combination of sender and receiver credentials, and the assessment of available offers based on the combined credentials, may be performed only if it has been determined that the qualifying offers available only to the sender are insufficient to cover the requested transfer (905:No). Continuing with the above example, in step 908 the system 700 may evaluate all of the previously unavailable offers at the both the sender's location 705a and the receiver's location 705b, using the combined sender-receiver risk rating determined in step 907. For instance, the system 700 may compare the combined sender-receiver credentials (combined credential=24) to the credential thresholds for previously available offers 1003 (credential threshold=25), 1004 (1003 (credential threshold=28), and 1006 (credential threshold=20), thereby determining that the combination of the sender and receiver qualifies for advance offer 1006 in the amount of $700.

In step 909, the system 700 may compare the sum of the qualifying offers identified in steps 901, 904, and 908 to the requested transfer amount. If the qualifying offers available at both the sender's and receiver's locations and based on the combined credentials of the sender and receiver are insufficient to cover the requested transfer (909:No), then the process may exit and transmit an indication to the sender's device 715 and/or receiver's device 720 that a qualifying offer combination could not be found. However, if the sum of the qualifying offers determined in steps 901, 904, and 908 is greater than or equal to than the requested transfer amount/value (909:Yes), then the process may continue to step 910. For instance, continuing with the above example, the system 700 may determine in step 909 that the sum of the qualifying advance offers available in the sender's location based on the sender's credentials ($100+$500=$600), plus the sum of the qualifying advance offers available in the receiver's location based on the sender's credentials ($100), plus the sum of the qualifying advance offers available at the both the sender's and the receiver's location based on the combined sender-receiver credentials ($700) is greater than the amount ($800) required to fully complete the requested transfer (909:No).

Based on the determination in step 909 that the sum of the qualifying offers determined in steps 901, 904, and 908 is greater than or equal to than the requested transfer amount/value (909:Yes), then the system 700 may determine that there is at least one combination of qualifying offers based on the combined sender and receiver credentials to cover the requested transfer. For instance, continuing the above example, the system 700 may determine that sender and receiver combination may be qualified under advance offer 1006 to borrow the remaining $100 needed to cover the full $800 amount of the requested transfer, along with the previously identified qualifying offers 1001 ($100), 1002 ($500), and 1005 ($100).

In step 910, after determining a qualifying offer combination in step 909, the system 700 may reassess all of the offers available within the sender's location 705a and the receiver's location 705b, based on the combined sender-receiver credentials determined in step 907. For instance, continuing the above example, the system 700 may compare the combined sender-receiver risk rating determine in step 907 (24) to the credential threshold values for all every offer 1001-1006 available at the sender's location 705a and/or the receiver's location 705b. In some cases, by reassessing all offers using the combined sender-receiver credentials, additional qualifying offer combinations may be determined. For example, because the system 700 determined in 908 that the sender-receiver combination qualifies for up to $700 for advance offer 1006 (i.e., not just the remaining $100 needed at that point in the initial analysis), the system 700 may determine in step 910 that the sender-receiver combination may qualify for multiple different advance combinations to fully cover the requested transfer amount. For instance, fully cover the requested transfer amount of $800 in this example, the transfer system 700 may identify several different possible qualifying offer combinations in step 910, such as: offer 1001 ($100)+offer 1006 ($700), or offer 1002 ($100)+offer 1006 ($700), or offer 1002 ($500)+offer 1006 ($200), or offer 1001 ($100)+offer 1005 ($100)+offer 1006 ($600), and so on.

In step 911, the system 700 may select a qualifying offer combination from the multiple different qualifying offer combinations determined in step 910 to cover the requested transfer. In some embodiments, the transfer system 730 and/or separate transfer instances 710a and 710b, may evaluate each of the combinations of qualifying offers determined in step 910 based on the offer terms or other factors. For instance, continuing with the above example, each of the different possible qualifying advance offer combinations that may be used to fully cover requested transfer amount of $800 may be evaluated in step 911, using various advance terms, conditions, and other factors (e.g., interest rates, payment schedules, etc.) to determine a preferred or optimal combination of advance offers for the requested transfer. In some embodiments, alternatively or in addition to performing such analyses, the system 700 may transmit the different qualifying offer combinations to the sender device 715 and/or the receiver device 720, and may receive a response from the from the sender and/or receiver device selecting one of the qualifying offer combinations.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A transfer system comprising:
a sender device comprising:
a processing unit comprising one or more processors;
an input/output (I/O) subsystem configured to receive input data via one or more input devices connected to or integral with the sender device; and
memory coupled with and readable by the processing unit and storing therein a set of instructions which, when executed by the processing unit, causes the sender device to:
based on input received via the I/O subsystem, transmit a transfer request to a transfer server identifying a transfer between a sender and a receiver, the request including a value associated with the transfer;
receive, from the transfer server, data identifying one or more offers associated with the transfer;
receive input via the I/O subsystem indicating a response to the received offers; and
transmit a confirmation to the transfer server indicating the response to the received offers;
a receiver device comprising:
a processing unit comprising one or more processors;
an input/output (I/O) subsystem configured to receive input data via one or more input devices connected to or integral with the receiver device; and
memory coupled with and readable by the processing unit and storing therein a set of instructions which, when executed by the processing unit, causes the receiver device to:
receive, from the transfer server, data identifying one or more offers associated with the transfer;
receive input via the I/O subsystem indicating a response to the received offers; and
transmit a confirmation to the transfer server indicating the response to the received offers;
one or more granter systems, each granter system comprising:
a processing unit comprising one or more processors; and
memory coupled with and readable by the processing unit and storing therein a set of instructions which, when executed by the processing unit, causes the granter system to:
transmit, to the transfer server, one or more data records corresponding to offers, each offer having an associated value; and
the transfer server, wherein the transfer server comprises:
a processing unit comprising one or more processors; and
memory coupled with and readable by the processing unit and storing therein a set of instructions which, when executed by the processing unit, causes the transfer server to:
receive, from the sender device, a request identifying the transfer between the sender and the receiver, the received request including the value associated with the transfer;
receive data records from each of the one or more granter systems, the data records corresponding to one or more offers;
determine sender credentials associated with the sender and determine receiver credentials associated with the receiver;
identify a first set of offers out of the received offers, based on the sender credentials;
determine a first aggregate value associated with the first set of offers;
compare the first aggregate value associated with the first set of offers to the value associated with the transfer between the sender and the receiver;
in response to a determination that the first aggregate value associated with the first set of offers is less than the value associated with the transfer, determine a combined set of credentials based on sender credentials and the receiver credentials;
identify a second set of offers out of the received offers, based on the combined set of credentials;
determine a second aggregate value associated with the second set of offers;
compare the second aggregate value associated with the second set of offers to the value associated with the transfer between the sender and the receiver;
in response to a determination that the second aggregate value associated with the second set of offers is greater than or equal to the value associated with the transfer, identify a third set offers out of the second set of offers for the transfer between the sender and the receiver;
transmit data identifying the third set of offers to the sender device;
receive a confirmation from the sender device indicating a response by the sender to the third set of offers for the transfer;
transmit data identifying the third set of offers to the receiver device; and
receive a confirmation from the receiver device indicating a response by the receiver to the third set of offers for the transfer.

2. The transfer system of claim 1, wherein identifying the first set of offers out of the received offers, based on the sender credentials, comprises:
determining a location associated with the sender device;
determining locations associated with each of the one or more granter systems;
identifying a first subset of granter systems having locations corresponding to the location associated with the sender device; and
identifying a first subset of offers received from the first subset of granter systems,
wherein the first set of offers is identified from the first subset of offers received from the first subset of granter systems.

3. The transfer system of claim 2, wherein determining the location associated with the sender device comprises at least one of:
retrieving network address information from the request received from the sender device; or
receiving, from the sender device, location data collected by a digital positioning system of the sender device.

4. The transfer system of claim 1, wherein the one or more granter systems include:
a first subset of granter systems comprising one or more granter systems within a first geographic domain associated with the sender device; and
a second subset of granter systems comprising one or more granter systems within a second geographic domain associated with the receiver device.

5. The transfer system of claim 4, wherein identifying the first set of offers out of the received offers, based on the sender credentials, comprises:
determining one or more qualifying offers received from the first subset of granter systems, based on the sender credentials;
reducing the value associated with the transfer by the sum of the aggregate value of the one or more qualifying offers received from the first subset of granter systems;
updating the sender credentials based on the sum of the aggregate value of the one or more qualifying offers received from the first subset of granter systems; and
determining one or more additional qualifying offers received from the second subset of granter systems, based on the updated sender credentials.

6. The transfer system of claim 5, wherein determining the combined set of credentials comprises:
calculating one or more combined authorization values associated with the sender and the receiver, based on the receiver credentials and the updated sender credentials.

7. The transfer system of claim 1, wherein determining the sender credentials comprises:
receiving first sender credential data associated with the sender;
determining that the sender will provide a portion of the value associated with the transfer; and
updating the first sender credential data based on the portion of the value the associated with the transfer that will be provided by the sender.

8. The transfer system of claim 1, the memory of the transfer server storing therein further instructions which, when executed by the processing unit, causes the transfer server to:
in response to the determination that the second aggregate value associated with the second set of offers is greater than or equal to the value associated with the transfer:
evaluating all of the received offers based on the combined set of credentials;
determining one or more qualifying offers based on the combined set of credentials;
determining a plurality of qualifying offer combinations, each qualifying offer combination including one or more of the qualifying offers determined based on the combined set of credentials, and each qualifying offer combination having an aggregate value greater than or equal to the value associated with the transfer; and
selecting a first qualifying offer combination from the plurality of qualifying offer combinations, wherein the third set of offers is within the first qualifying offer combination.

9. The transfer system of claim 8, wherein the first qualifying offer combination does not include at least one of the first set of offers identified based on the sender credentials.

10. The transfer system of claim 8, wherein determining the first qualifying offer combination from the plurality of qualifying offer combinations comprises:
transmitting data corresponding to each of the plurality of qualifying offer combinations to the sender device;
receiving, from the sender device, response data indicating a sender selection of the first qualifying offer combination.

11. A method comprising:
receiving, by a transfer server, a request identifying a transfer between a sender and a receiver, the received request including a value associated with the transfer;
receiving, by the transfer server, one or more data records from each of one or more granter systems, the data records corresponding to one or more offers;
determining, by the transfer server, sender credentials associated with the sender, and determining receiver credentials associated with the receiver;
identifying, by the transfer server, a first set of offers out of the received offers, based on the sender credentials;
determining, by the transfer server, a first aggregate value associated with the first set of offers;
comparing, by the transfer server, the first aggregate value associated with the first set of offers to the value associated with the transfer between the sender and the receiver;
in response to a determination that the first aggregate value associated with the first set of offers is less than the value associated with the transfer, determining, by the transfer server, a combined set of credentials based on sender credentials and the receiver credentials;
identifying, by the transfer server, a second set of offers out of the received offers, based on the combined set of credentials;
determining, by the transfer server, a second aggregate value associated with the second set of offers;
comparing, by the transfer server, the second aggregate value associated with the second set of offers to the value associated with the transfer between the sender and the receiver;
in response to a determination that the second aggregate value associated with the second set of offers is greater than or equal to the value associated with the transfer, identifying, by the transfer server, a third set offers out of the second set of offers for the transfer between the sender and the receiver;
transmitting, by the transfer server, data identifying the third set of offers to a sender device associated with the sender;
receiving, by the transfer server, a confirmation from the sender device indicating a response by the sender to the third set of offers for the transfer;
transmitting, by the transfer server, data identifying the third set of offers to a receiver device associated with the receiver; and
receiving, by the transfer server, a confirmation from the receiver device indicating a response by the receiver to the third set of offers for the transfer.

12. The method of claim 11, wherein identifying the first set of offers out of the received offers, based on the sender credentials, comprises:
determining a location associated with the sender device;
determining locations associated with each of the one or more granter systems;
identifying a first subset of granter systems having locations corresponding to the location associated with the sender device; and
identifying a first subset of offers received from the first subset of granter systems,
wherein the first set of offers is identified from the first subset of offers received from the first subset of granter systems.

13. The method of claim 12, wherein determining the location associated with the sender device comprises at least one of:
retrieving network address information from the request received from the sender device; or
receiving, from the sender device, location data collected by a digital positioning system of the sender device.

14. The method of claim 11, wherein the one or more granter systems include:
a first subset of granter systems comprising one or more granter systems within a first geographic domain associated with the sender device; and
a second subset of granter systems comprising one or more granter systems within a second geographic domain associated with the receiver device.

15. The method of claim 14, wherein identifying the first set of offers out of the received offers, based on the sender credentials, comprises:
determining one or more qualifying offers received from the first subset of granter systems, based on the sender credentials;
reducing the value associated with the transfer by the sum of the aggregate value of the one or more qualifying offers received from the first subset of granter systems;
updating the sender credentials based on the sum of the aggregate value of the one or more qualifying offers received from the first subset of granter systems; and
determining one or more additional qualifying offers received from the second subset of granter systems, based on the updated sender credentials.

16. The method of claim 15, wherein determining the combined set of credentials comprises:
calculating one or more combined authorization values associated with the sender and the receiver, based on the receiver credentials and the updated sender credentials.

17. The method of claim 11, wherein determining the sender credentials comprises:
receiving first sender credential data associated with the sender;
determining that the sender will provide a portion of the value associated with the transfer; and
updating the first sender credential data based on the portion of the value the associated with the transfer that will be provided by the sender.

18. The method of claim 11, further comprising:
in response to the determination that the second aggregate value associated with the second set of offers is greater than or equal to the value associated with the transfer:
evaluating all of the received offers based on the combined set of credentials;
determining one or more qualifying offers based on the combined set of credentials;
determining a plurality of qualifying offer combinations, each qualifying offer combination including one or more of the qualifying offers determined based on the combined set of credentials, and each qualifying offer combination having an aggregate value greater than or equal to the value associated with the transfer; and
selecting a first qualifying offer combination from the plurality of qualifying offer combinations, wherein the third set of offers is within the first qualifying offer combination.

19. The method of claim 18, wherein the first qualifying offer combination does not include at least one of the first set of offers identified based on the sender credentials.

20. The method of claim 18, wherein determining the first qualifying offer combination from the plurality of qualifying offer combinations comprises:
transmitting data corresponding to each of the plurality of qualifying offer combinations to the sender device;
receiving, from the sender device, response data indicating a sender selection of the first qualifying offer combination.
